(19) United States
(12) Patent Application Publication
(10) Pub. No.: US 2025/0363500 A1
(43) Pub. Date: Nov. 27, 2025

(54) ELECTRONIC SYSTEMS GENERATING PRODUCT TESTING INSTRUCTIONS AND FOR PROVIDING AUTOMATED PRODUCT TESTING

(71) Applicant: Rainforest QA, Inc., San Francisco, CA (US)

(72) Inventor: Maciej GRYKA, Potsdam (DE)

(21) Appl. No.: 18/670,659

(22) Filed: May 21, 2024

(51) Int. Cl. G06Q 30/018; G06V 10/82; G06V 30/10; G06V 30/41

(52) U.S. Cl. CPC G06Q 30/018; G06V 10/82; G06V 30/10; G06V 30/41

(57) ABSTRACT

An electronic system includes: a product retriever configured to access a product; an image capturer configured to capture one or more images of the product; and one or more processing units configured to generate prompts for input to a neural network, wherein the prompts are configured to prompt the neural network to determine a feature of the product based on at least one of the one or more captured images, determine a suggested testing for the feature of the product, perform a verification to determine whether the suggested testing for the feature of the product can be performed, and generate product testing instruction after the verification is performed.

### FIELD

This application relates generally to product testing, and more specifically, to systems and methods for providing product testing instruction and for providing automated product testing.

### BACKGROUND

Many products require product testing. Supplier of products generally require products be tested before they can be made available to customers. Sometimes, after a product has been made available, it may still be desirable to test the product. Testing of products can be a lengthy and complicated process. There may be many different technical features in the product that need to be tested under different testing parameters. Many product suppliers may not have in-house product testers. These product suppliers will need to outsource product testing to outside product testers. However, finding the right product testers who can adequately perform the product testing project can itself be a time-consuming process, and can be challenging. If the product supplier needs fast turn-around time for the product testing for its product, such out-sourcing technique may not be suitable.

In some cases, product testing device may be provided to perform product testing automatically. However, this requires user to create product testing instruction for execution by the product testing device. Creating product testing instruction is a time-consuming and labor-intensive process. Sometimes it may take a long time to generate product testing instruction. Even if a set of workable product testing instruction is created for a product, the product may change overtime (due to the product provider adjusting a feature of the product, adding a feature of the product, or removing a feature of the product). Thus, the created product testing instruction may not work properly for the changed product. Debugging and adjusting the product testing instruction are also expensive processes.

### SUMMARY

An electronic system includes: a product retriever configured to access a product; an image capturer configured to capture one or more images of the product; one or more processing units configured to obtain the one or more images captured by the image capturer, determine a feature of the product based on at least one of the one or more captured images, determine a suggested testing for the feature of the product, perform a verification to determine whether the suggested testing for the feature of the product can be performed, and obtain product testing instruction that is generated automatically after the verification is performed.

Optionally, the one or more processing units comprises a first processing unit configured to determine the feature of the product based on the at least one of the one or more captured images.

Optionally, the first processing unit is configured to determine the feature of the product utilizing a first neural network.

Optionally, the first processing unit is configured to determine the feature of the product by accessing the first neural network.

Optionally, the first neural network is a part of the first processing unit.

Optionally, the first neural network comprises ChatGPT.

Optionally, the one or more processing unit comprises a second processing unit configured to perform the verification to determine whether the suggested testing for the feature of the product can be performed.

Optionally, the second processing unit is configured to utilize the first neural network to perform the verification to determine whether the suggested testing for the feature of the product can be performed.

Optionally, the second processing unit is configured to perform the verification to determine whether the suggested testing for the feature of the product can be performed by accessing the first neural network.

Optionally, the first neural network is a part of the first processing unit, and a part of the second processing unit.

Optionally, the second processing unit is configured to utilize a second neural network to perform the verification to determine whether the suggested testing for the feature of the product can be performed.

Optionally, the second processing unit is configured to provide feedback to the first processing unit if the second processing unit determines that the suggested testing for the feature of the product cannot be performed.

Optionally, the first processing unit is configured to determine another feature of the product and/or to determine another suggested testing based on the feedback, and wherein the first processing unit is configured to determine the other feature of the product and/or to determine the other suggested testing utilizing the first neural network.

Optionally, the one or more processing units comprises a third processing unit configured to obtain the product testing instruction.

Optionally, the third processing unit comprises a product testing instruction generator, or is configured to interface with the product testing instruction generator.

Optionally, the third processing unit is configured to obtain OCR data and DOM data, and wherein the third processing unit is configured to obtain the product testing instruction based on at least a part of the OCR data and at least a part of the DOM data.

Optionally, the first processing unit, the second processing unit, and the third processing unit are configured to access the first neural network.

Optionally, the first neural network forms a part of the first processing unit, a part of the second processing unit, and a part of the third processing unit.

Optionally, the electronic system further includes: a product testing device configured to execute the product testing instruction to perform testing of the product based on the product testing instruction; wherein the product testing device is configured to perform the testing of the product by simulating human actions based on the product testing instruction.

Optionally, the product testing device is configured to move a cursor without input from a cursor control.

Optionally, the product testing device is configured to make a selection of an object without input from a cursor control.

Optionally, the product testing device is configured to insert a text in a field without input from a keyboard.

Optionally, the product testing device comprises an interpreter configured to interpret the product testing instruction.

Optionally, the one or more processing units are configured to access a first set of items and a second set of items, wherein the first set of items comprises a plurality of action identifiers, and the second set of items comprises a plurality of objects.

Optionally, one of the action identifiers identifies an action to be performed by the product testing device, and one of the object identifiers identifies an object on which the action is to be performed by the product testing device.

Optionally, one of the action identifiers identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

Optionally, one of the object identifiers identifies a button, a field, a dropdown menu, a dropdown option, a link, an icon, a checkbox, a header, a window, a text, a modal, or an user interface element.

Optionally, the product testing instruction has a data structure that associates an action identifier with a corresponding object identifier:

Optionally, the action identifier identifies an action to be performed by the product testing device, and the object identifier identifies an object on which the action is to be performed by the product testing device.

Optionally, the action identifier identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

Optionally, the object identifier identifies a button, a field, a dropdown menu, a dropdown option, a link, an icon, a checkbox, a header, a window, a text, a modal, or an user interface element.

Optionally, the electronic system further includes a non-transitory medium storing the product testing instruction in association with an identity of the product.

Optionally, the product testing device is configured to check if an element is visible after the product testing device performs a testing action.

Optionally, the product testing device is configured to check if an element is not visible after the product testing device performs a testing action.

Optionally, the product testing device is configured to check if a specified page has loaded after the product testing device performs a testing action.

Optionally, the product testing device is configured to: obtain a first image that is associated with the testing of the product, obtain a second image, the second image being a reference image that is pre-determined before the first image is obtained, perform a comparison based on the first image and the second image, and determine whether the product passes or fails a product testing task based on a result of the comparison.

Optionally, the first image is based on a completion of the product testing task performed during the testing of the product.

Optionally, the product comprises a web page, a web site, a computer application, a mobile device application, or a processor application.

Optionally, the product testing device is configured to perform machine-based testing of the product.

Optionally, the one or more processing units are implemented as a prompt generator interfacing with a neural network.

Optionally, the electronic system further includes an action retriever configured to obtain past testing information regarding past human-testing action and/or past machine-testing action, and to provide the past testing information to the one or more processing units for guiding an operation of the one or more processing units.

A method performed by an electronic system, includes: accessing a product; capturing one or more images of the product by an image capturer; obtaining the one or more images captured by the image capturer; determining a feature of the product based on at least one of the one or more captured images; determining a suggested testing for the feature of the product; performing a verification to determine whether the suggested testing for the feature of the product can be performed; and obtaining product testing instruction that is generated automatically after the verification is performed.

Optionally, the feature of the product is determined by a first processing unit of the electronic system based on the at least one of the one or more captured images.

Optionally, the feature of the product is determined by the first processing unit utilizing a first neural network.

Optionally, the feature of the product is determined by the first processing unit accessing the first neural network.

Optionally, the first neural network is a part of the first processing unit.

Optionally, the first neural network comprises ChatGPT.

Optionally, the verification is performed by a second processing unit to determine whether the suggested testing for the feature of the product can be performed.

Optionally, the verification is performed by the second processing unit utilizing the first neural network to determine whether the suggested testing for the feature of the product can be performed.

Optionally, the verification is performed by the second processing unit to determine whether the suggested testing for the feature of the product can be performed by accessing the first neural network.

Optionally, the first neural network is a part of the first processing unit, and a part of the second processing unit.

Optionally, the verification is performed by the second processing unit utilizing a second neural network to determine whether the suggested testing for the feature of the product can be performed.

Optionally, the method further includes providing feedback, by the second processing unit, to the first processing unit if the second processing unit determines that the suggested testing for the feature of the product cannot be performed.

Optionally, the method further includes determining by the first processing unit another feature of the product, and/or determining by the first processing unit another suggested testing based on the feedback, utilizing the first neural network.

Optionally, the product testing instruction is generated by a testing instruction generator that is a part of a third processing unit, or a part of a neural network.

Optionally, the method further includes receiving, by the third processing unit, an input from the second processing unit.

Optionally, the method further includes obtaining OCR data and DOM data by the third processing unit, wherein the product testing instruction is generated based on at least a part of the OCR data and at least a part of the DOM data.

Optionally, the first processing unit, the second processing unit, and the third processing unit are configured to access the first neural network.

Optionally, the first neural network forms a part of the first processing unit, a part of the second processing unit, and a part of the third processing unit.

Optionally, the method further includes executing the product testing instruction, by a product testing device, to perform testing of the product based on the product testing instruction.

Optionally, the product testing instruction is executed to move a cursor without input from a cursor control.

Optionally, the product testing instruction is executed to make a selection of an object without input from a cursor control.

Optionally, the product testing instruction is executed to insert a text in a field without input from a keyboard.

Optionally, the product testing instruction is executed by the product testing device to interpret the product testing instruction.

Optionally, the method further includes accessing, by a product testing instruction generator, a first set of items and a second set of items, wherein the first set of items comprises a plurality of action identifiers, and the second set of items comprises a plurality of objects.

Optionally, one of the action identifiers identifies an action to be performed by the product testing device, and one of the object identifiers identifies an object on which the action is to be performed by the product testing device.

Optionally, one of the action identifiers identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

Optionally, one of the object identifiers identifies a button, a field, a dropdown menu, a dropdown option, a link, an icon, a checkbox, a header, a window, a text, a modal, or an user interface element.

Optionally, the product testing instruction has a data structure that associates an action identifier with a corresponding object identifier:

Optionally, the action identifier identifies an action to be performed by the product testing device, and the object identifier identifies an object on which the action is to be performed by the product testing device.

Optionally, the action identifier identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

Optionally, the object identifier identifies a button, a field, a dropdown menu, a dropdown option, a link, an icon, a checkbox, a header, a window, a text, a modal, or an user interface element.

Optionally, the method further includes storing the product testing instruction in a non-transitory medium in association with an identity of the product.

Optionally, the method further includes checking, by the product testing device, if an element is visible after the product testing device performs a testing action.

Optionally, the method further includes checking, by the product testing device, if an element is not visible after the product testing device performs a testing action.

Optionally, the method further includes checking, by the product testing device, if a specified page has loaded after the product testing device performs a testing action.

Optionally, the method further includes: obtaining a first image that is associated with the testing of the product, obtaining a second image, the second image being a reference image that is pre-determined before the first image is obtained, performing a comparison based on the first image and the second image, and determining whether the product passes or fails a product testing task based on a result of the comparison.

Optionally, the first image is based on a completion of the product testing task performed during the testing of the product.

Optionally, the product comprises a web page, a web site, a computer application, a mobile device application, or a processor application.

Optionally, the product testing device is configured to perform machine-based testing of the product.

Optionally, the act of determining the feature of the product, the act of determining the suggested testing for the feature of the product, and the act of performing the verification to determine whether the suggested testing for the feature of the product can be performed, are performed by one or more neural networks that receive prompts from a prompt generator.

Optionally, the method further includes: obtaining past testing information regarding past human-testing action and/or past machine-testing action, and providing the past testing information to one or more processing units of the electronic system for guiding an operation of the one or more processing units.

An electronic system includes: a product retriever configured to access a product; an image capturer configured to capture one or more images of the product; and one or more processing units configured to generate prompts for input to a neural network, wherein the prompts are configured to prompt the neural network to determine a feature of the product based on at least one of the one or more captured images, determine a suggested testing for the feature of the product, perform a verification to determine whether the suggested testing for the feature of the product can be performed, and generate product testing instruction after the verification is performed.

Optionally, the prompts comprise a first set of prompts, and wherein the one or more processing units comprises a first prompt generator configured to generate the first set of prompts to cause the neural network to determine the feature of the product based on the at least one of the one or more captured images.

Optionally, the prompts comprise a second set of prompts, and wherein the one or more processing unit comprises a second prompt generator configured to generate the second set of prompts to cause the neural network to perform the verification to determine whether the suggested testing for the feature of the product can be performed.

Optionally, the prompts comprise a third set of prompts, and wherein the one or more processing units comprises a third prompt generator configured to generate the third set of prompts to cause the neural network to generate the product testing instruction.

Optionally, the one or more processing units are configured to obtain OCR data and/or DOM data, and to provide the OCR data and/or the DOM data along with the third set of prompts to cause the neural network to generate the product testing instruction based on at least a part of the OCR data and/or at least a part of the DOM data.

Optionally, the neural network is separate from the one or more processing units, and wherein the one or more processing units are configured to access the neural network.

Optionally, the one or more processing units comprise the neural network.

Optionally, the neural network comprises a plurality of neural network models, and wherein the one or more processing units are configured to access respective ones of the neural network models.

Optionally, the neural network comprises a plurality of neural network models, and wherein the one or more processing units comprise respective ones of the neural network models.

Optionally, the neural network comprises ChatGPT.

Optionally, the one or more processing units are configured to obtain feedback from the neural network indicating that the suggested testing for the feature of the product cannot be performed.

Optionally, the one or more processing units are configured to generate additional prompts based on the feedback to cause the neural network to determine another feature of the product and/or to determine another suggested testing.

Optionally, the electronic system further includes: a product testing device configured to execute the product testing instruction to perform testing of the product based on the product testing instruction; wherein the product testing device is configured to perform the testing of the product by simulating human actions based on the product testing instruction.

Optionally, the product testing device is configured to move a cursor without input from a cursor control.

Optionally, the product testing device is configured to make a selection of an object without input from a cursor control.

Optionally, the product testing device is configured to insert a text in a field without input from a keyboard.

Optionally, the product testing device comprises an interpreter configured to interpret the product testing instruction.

Optionally, the one or more processing units are configured to access a first set of items and a second set of items for the neural network or to provide the first set of items and the second set of items for access by the neural network, wherein the first set of items comprises a plurality of action identifiers, and the second set of items comprises a plurality of objects.

Optionally, one of the action identifiers identifies an action to be performed by the product testing device, and one of the object identifiers identifies an object on which the action is to be performed by the product testing device.

Optionally, one of the action identifiers identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

Optionally, one of the object identifiers identifies a button, a field, a dropdown menu, a dropdown option, a link, an icon, a checkbox, a header, a window, a text, a modal, or an user interface element.

Optionally, the product testing instruction has a data structure that associates an action identifier with a corresponding object identifier:

Optionally, the action identifier identifies an action to be performed by the product testing device, and the object identifier identifies an object on which the action is to be performed by the product testing device.

Optionally, the action identifier identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

Optionally, the object identifier identifies a button, a field, a dropdown menu, a dropdown option, a link, an icon, a checkbox, a header, a window, a text, a modal, or an user interface element.

Optionally, the electronic system further includes a non-transitory medium storing the product testing instruction in association with an identity of the product.

Optionally, the product testing device is configured to check if an element is visible after the product testing device performs a testing action.

Optionally, the product testing device is configured to check if an element is not visible after the product testing device performs a testing action.

Optionally, the product testing device is configured to check if a specified page has loaded after the product testing device performs a testing action.

Optionally, the product testing device is configured to: obtain a first image that is associated with the testing of the product, obtain a second image, the second image being a reference image that is pre-determined before the first image is obtained, perform a comparison based on the first image and the second image, and determine whether the product passes or fails a product testing task based on a result of the comparison.

Optionally, the first image is based on a completion of the product testing task performed during the testing of the product.

Optionally, the product comprises a web page, a web site, a computer application, a mobile device application, or a processor application.

Optionally, the one or more processing units comprise an action retriever configured to obtain past testing information regarding past human-testing action and/or past machine-testing action, and to provide the past testing information to the neural network for guiding an operation of the neural network.

A method performed by an electronic system, includes: accessing a product; capturing one or more images of the product by an image capturer of the electronic system; and generating, by one or more processing units of the electronic system, prompts for input to a neural network, wherein the prompts are configured to prompt the neural network to: determine a feature of the product based on at least one of the one or more captured images, determine a suggested testing for the feature of the product, perform a verification to determine whether the suggested testing for the feature of the product can be performed, and generate product testing instruction after the verification is performed.

Optionally, the prompts comprise a first set of prompts to cause the neural network to determine the feature of the product based on the at least one of the one or more captured images, wherein the one or more processing units comprises a first prompt generator, and wherein the first set of prompts are generated by the first prompt generator.

Optionally, the prompts comprise a second set of prompts to cause the neural network to perform the verification to determine whether the suggested testing for the feature of the product can be performed, wherein the one or more processing unit comprises a second prompt generator, and wherein the second set of prompts are generated by the second prompt generator.

Optionally, the prompts comprise a third set of prompts to cause the neural network to generate the product testing instruction, wherein the one or more processing units comprises a third prompt generator, and wherein the third set of prompts are generated by the third prompt generator.

Optionally, the method further includes: obtaining, by the one or more processing units, OCR data and/or DOM data; and providing the OCR data and/or the DOM data along with the third set of prompts to cause the neural network to generate the product testing instruction based on at least a part of the OCR data and/or at least a part of the DOM data.

Optionally, the neural network is separate from the one or more processing units, and wherein the one or more processing units are configured to access the neural network.

Optionally, the one or more processing units comprise the neural network.

Optionally, the neural network comprises a plurality of neural network models, and wherein the one or more processing units are configured to access respective ones of the neural network models.

Optionally, the neural network comprises a plurality of neural network models, and wherein the one or more processing units comprise respective ones of the neural network models.

Optionally, the neural network comprises ChatGPT.

Optionally, the method further includes obtaining, by the one or more processing units feedback from the neural network indicating that the suggested testing for the feature of the product cannot be performed.

Optionally, the method further includes generating, by the one or more processing units, additional prompts based on the feedback to cause the neural network to determine another feature of the product and/or to determine another suggested testing.

Optionally, the method further includes executing the product testing instruction, by a product testing device, to perform testing of the product based on the product testing instruction.

Optionally, the product testing instruction is executed to move a cursor without input from a cursor control.

Optionally, the product testing instruction is executed to make a selection of an object without input from a cursor control.

Optionally, the product testing instruction is executed to insert a text in a field without input from a keyboard.

Optionally, the product testing instruction is executed by the product testing device to interpret the product testing instruction.

Optionally, the method further includes accessing a first set of items and a second set of items for the neural network or providing the first set of items and the second set of items for access by the neural network, wherein the first set of items comprises a plurality of action identifiers, and the second set of items comprises a plurality of objects.

Optionally, one of the action identifiers identifies an action to be performed by the product testing device, and one of the object identifiers identifies an object on which the action is to be performed by the product testing device.

Optionally, one of the action identifiers identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

Optionally, one of the object identifiers identifies a button, a field, a dropdown menu, a dropdown option, a link, an icon, a checkbox, a header, a window, a text, a modal, or an user interface element.

Optionally, the product testing instruction has a data structure that associates an action identifier with a corresponding object identifier:

Optionally, the action identifier identifies an action to be performed by the product testing device, and the object identifier identifies an object on which the action is to be performed by the product testing device.

Optionally, the action identifier identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

Optionally, the object identifier identifies a button, a field, a dropdown menu, a dropdown option, a link, an icon, a checkbox, a header, a window, a text, a modal, or an user interface element.

Optionally, the method further includes storing the product testing instruction in a non-transitory medium in association with an identity of the product.

Optionally, the method further includes checking, by the product testing device, if an element is visible after the product testing device performs a testing action.

Optionally, the method further includes checking, by the product testing device, if an element is not visible after the product testing device performs a testing action.

Optionally, the method further includes checking, by the product testing device, if a specified page has loaded after the product testing device performs a testing action.

Optionally, the method further includes: obtaining a first image that is associated with the testing of the product, obtaining a second image, the second image being a reference image that is pre-determined before the first image is obtained, performing a comparison based on the first image and the second image, and determining whether the product passes or fails a product testing task based on a result of the comparison.

Optionally, the first image is based on a completion of the product testing task performed during the testing of the product.

Optionally, the product comprises a web page, a web site, a computer application, a mobile device application, or a processor application.

Optionally, the method further includes obtaining past testing information regarding past human-testing action and/or past machine-testing action, and providing the past testing information to the neural network for guiding an operation of the neural network.

Other and further aspects and features will be evident from reading the following detailed description of the embodiments.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates an electronic system in accordance with some embodiments.

FIG. 2 illustrates a variation of the electronic system of FIG. 1.

FIGS. 3A-3B illustrate examples of prompts, commands, or conversations for a processing unit of the electronic system of FIG. 1, wherein the processing unit is configured to suggest a testing for a feature of a product.

FIG. 3C illustrates an example of an image provided to a processing unit of the electronic system of FIG. 1.

FIG. 3D illustrates an example of an output provided by a processing unit of the electronic system of FIG. 1.

FIGS. 4A-4B illustrate examples of prompts, commands, or conversations for a processing unit of the electronic system of FIG. 1, wherein the processing unit is configured to verify whether a suggested testing for a feature of a product can be performed.

FIG. 4C illustrates an example of images provided to a processing unit of the electronic system of FIG. 1.

FIG. 4D illustrates an example of an output provided by a processing unit of the electronic system of FIG. 1.

FIGS. 5A-5D illustrate examples of prompts, commands, or conversations for a processing unit of the electronic system of FIG. 1, wherein the processing unit is configured to generate product testing instruction to test a feature of a product.

FIGS. 5E-5G illustrate an example of input provided to a processing unit of the electronic system of FIG. 1.

FIG. 5H illustrates an example of an output provided by a processing unit of the electronic system of FIG. 1.

FIG. 6A illustrates a user interface provided by the electronic system, particularly showing the electronic system suggesting a testing for a feature of a product, verifying that the suggested testing can be performed, and generating product testing instruction to test the feature of the product.

FIG. 6B illustrates a close-up view of a part of the user interface of FIG. 6A.

FIG. 7A illustrates a user interface provided by the electronic system, particularly showing the electronic system suggesting a testing for another feature of a product, verifying that the suggested testing can be performed, and generating product testing instruction to test the other feature of the product.

FIG. 7B illustrates a close-up view of a part of the user interface of FIG. 4A.

FIG. 8A illustrates a user interface provided by the electronic system, particularly showing the electronic system suggesting a testing for another feature of a product, verifying that the suggested testing can be performed, and generating product testing instruction to test the other feature of the product.

FIG. 8B illustrates a close-up view of a part of the user interface of FIG. 5A.

FIGS. 9A-9B illustrates examples of action identifiers that may be inputted or selected by user via a user interface.

FIG. 9C illustrates examples of object identifiers that may be inputted or selected by user via a user interface.

FIG. 10 illustrates a method for use in product testing.

FIG. 11 is a block diagram of a specialized processing system.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

### Electronic System

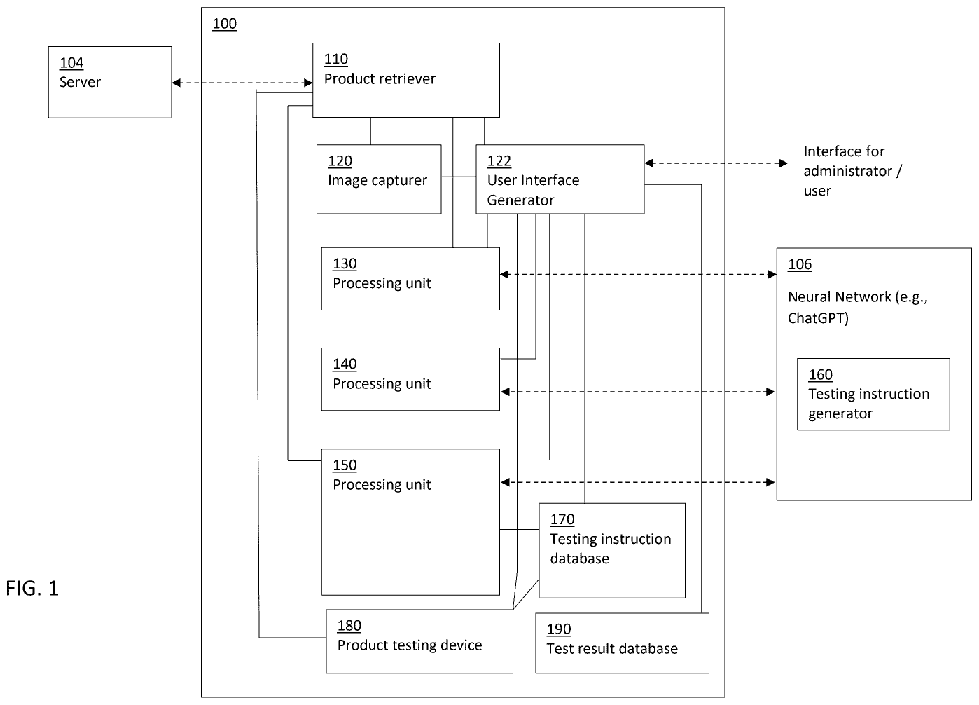

FIG. 1 illustrates an electronic system 100 in accordance with some embodiments. The electronic system 100 is configured to automatically generate testing instruction, and to perform product testing to test a product (e.g., application, website, webpage, software, etc.) based on the generated testing instruction.

The electronic system 4000 includes a product retriever 110, an image capturer 120, a user interface 122, a first processing unit 130, a second processing unit 140, a third processing unit 150, a testing instruction database 170, a product testing machine 180, and a test result database 190.

The product retriever 110 is configured to communicate with a server 104 to retrieve information regarding a product to be tested. For example, the product retriever 110 may communicate with the server 104 via the Internet, and access a website (an example of product to be tested) having one or more webpages. In some cases, the product retriever 110 may include a web-browser configured to access a website.

The image capturer 120 is configured to capture an image of the product to be tested, and to provide the image to the first processing unit 130 and/or the second processing unit 140. In the illustrated example, the product to be tested is a website with one or more webpages. Thus, the image capturer 120 is configured to capture an image of the website (e.g., a webpage image), and to provide the webpage image to the first processing unit 130 and/or the second processing unit 140.

### First Processing Unit

The first processing unit 130 is configured to provide the webpage image captured by the image capturer 120 to a neural network (e.g., ChatGPT) 106, which identifies one or more features in the webpage based on the webpage image. In some cases, the first processing unit 130 may also provide a prompt (e.g., an inquiry, an instruction, etc.) along with the webpage image to the neural network 106. For example, the first processing unit 130 may provide the prompt “Identify a feature of the webpage and the purpose of the feature of the webpage” along with the webpage image. In other cases, the first processing unit 130 may be configured to provide only the webpage image without any prompt to the neural network 106. The neural network 106 may include a scene interpreter configured to interpret a scene (e.g., the webpage image). The neural network 106 may be configured to analyze the webpage image and to identify one or more features of the webpage and to determine the purpose of the webpage in response to the prompt provided by the first processing unit 130. For example, the neural network 106 may determine that the webpage image includes an email address filed, and may determine that the purpose of the email address field is for a user to enter an email address as contact information. As another example, the neural network 106 may determine that the webpage image includes a field for entering a last name, and may determine that the purpose of the name field is for a user to enter a last name.

In some embodiments, the first processing unit 130 may be configured to automatically provide one or more prompts for input to the neural network 106. Such prompt(s) may be the same for different products, and therefore they may be stored in a non-transitory medium for the first processing unit 130 to retrieve.

In some cases, the first processing unit 130 may obtain additional input that may or may not be the same for the different products, and may provide such additional input to the neural network 106. In some embodiments, if certain task(s) has been completed during a product testing, the first processing unit 130 may provide such information to the neural network 106. Such information may assist the neural network 106 in determining the context and/or purpose of the current webpage based on previous action(s) performed in association with the webpage. For example, if a product testing includes a click-and-fill action that has been performed, the first processing unit 130 may inform the neural network 106 that the following actions have been completed so far: (1) “click on login button” and (2) “fill first name field with ‘Bob’”.

Also, in some cases, the first processing unit 130 may obtain similar data from the past to guide the neural network 106. In particular, if human testers or machine testers have completed a similar product testing task in the past, the first processing unit 130 may retrieve identifiers of the actions performed for the task, and provide such action identifiers (identifying past human testing actions, and/or past machine testing actions) to the neural network 106. For example, the first processing unit 130 may indicate to the neural network 106 that actions performed for similar task in the past includes: (1) fill, (2) fill, (3) scroll, and (4) fill. Such information may assist the neural network 106 in determining the contest and/or purpose of the webpage. In one implementation, the electronic system 100 may include a database, or may be configured to access a database, storing action identifiers identifying previous product testing actions performed to test certain types of features of products. In such cases, the first processing unit 130 may obtain the action identifiers from the database, and insert them with the prompts for input to the neural network 106. In some cases, the electronic system 100 may obtain related actions from the past and provide them to the first processing unit 130, so that the first processing unit 130 can include such data in its generated prompts (e.g., ChatGPT query). In one implementation, the electronic system 100 may include an action retriever configured to retrieve these related actions (past testing information) from a database (e.g., vector database), and to provide the past testing information to the one or more processing units (e.g., processing units 130, 140, 150, and/or neural network(s), such as neural network 106) for guiding an operation of the one or more processing units. The retrieval may be based on semantic similarity of the current instructions to the past instructions.

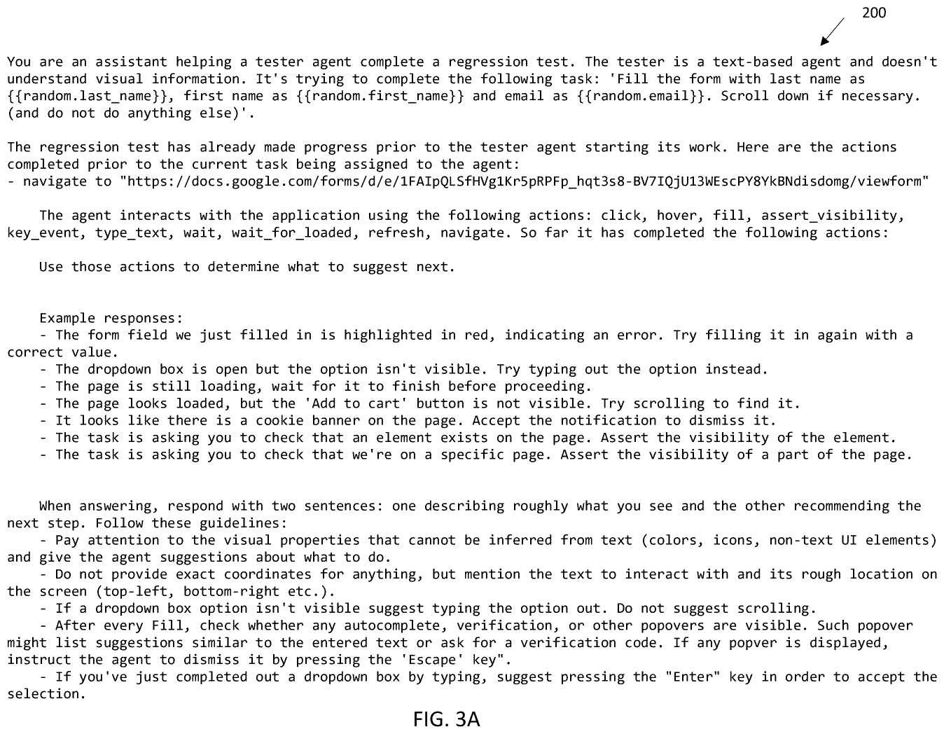

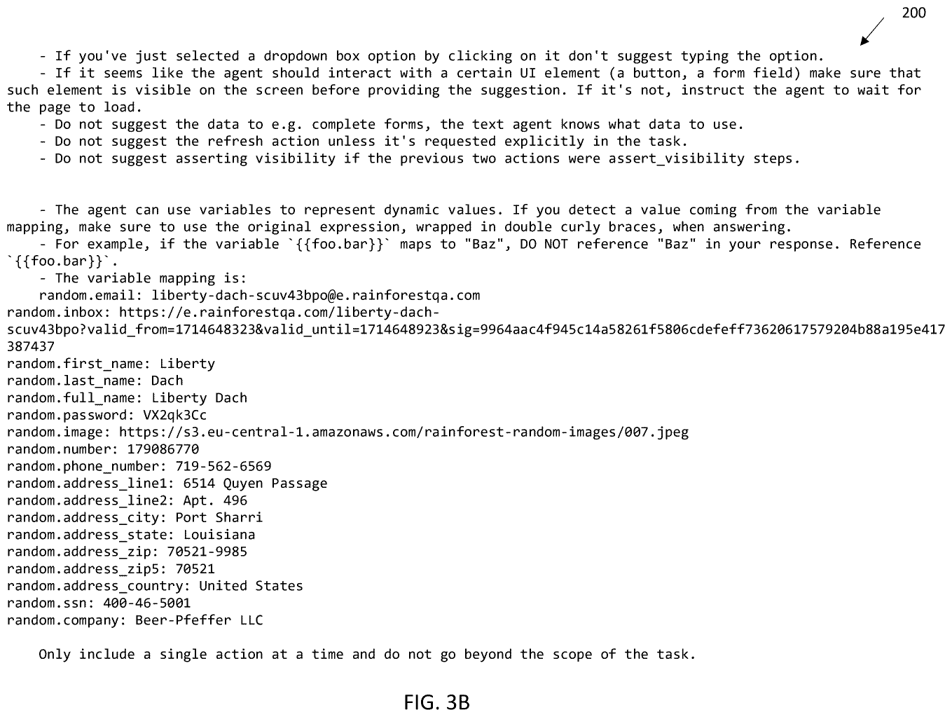

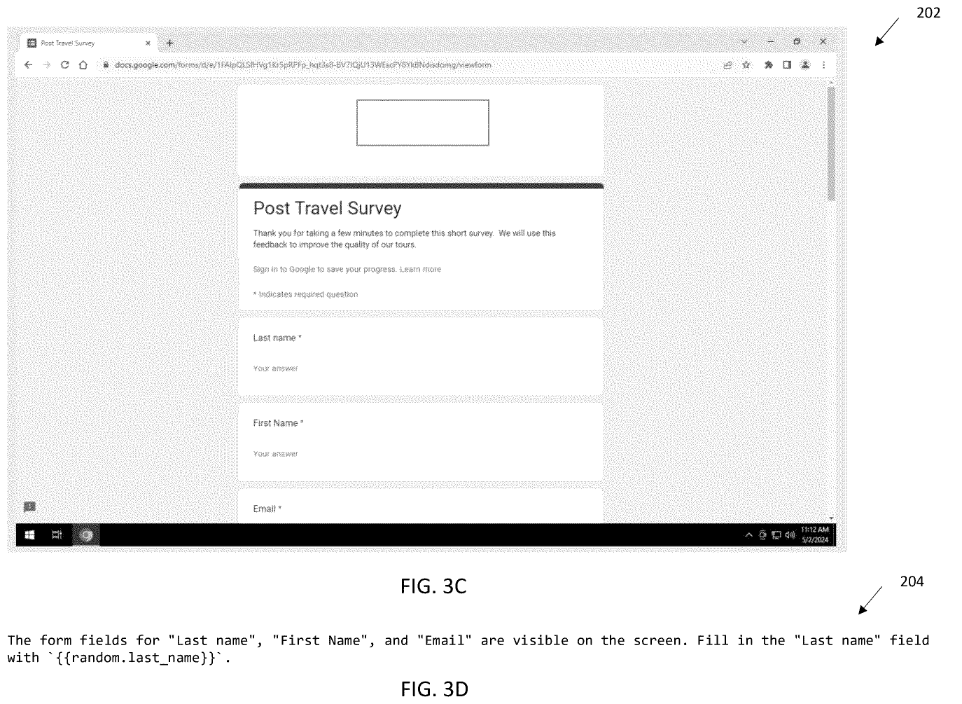

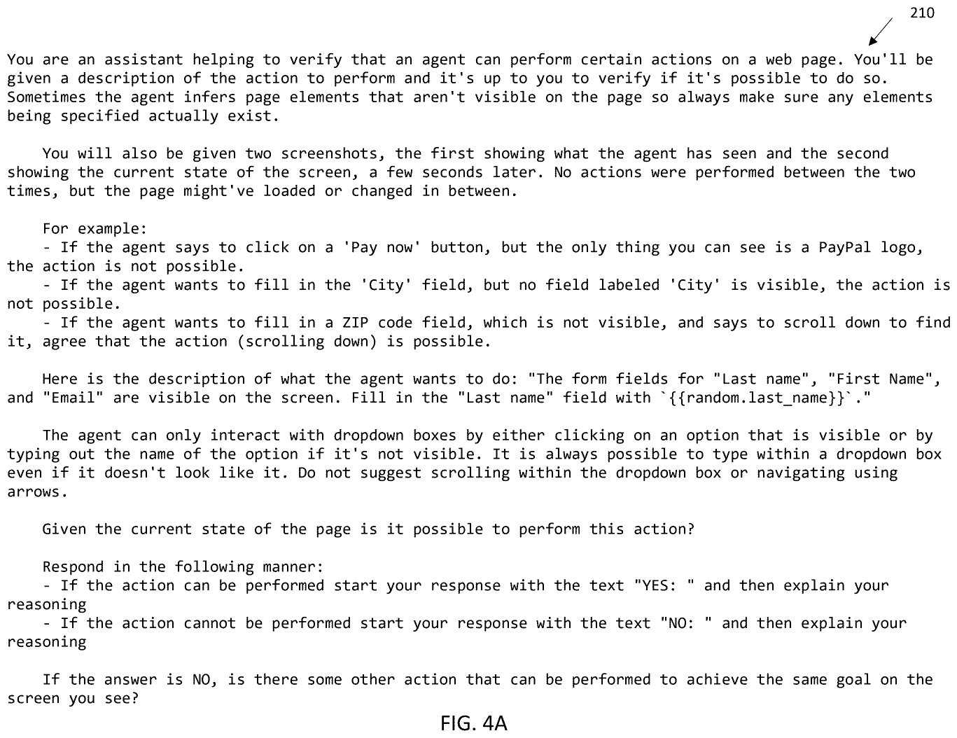

More specific examples of prompts 200 provided by the first processing unit 130 are shown in FIGS. 3A-3B. The first processing unit 130 may be configured to generate one or more of the prompts 200 automatically. The prompts 200 are configured to guide the neural network 106 to provide a desirable output. In the illustrated examples, the prompts 200 are configured to request the neural network 106 to identify a feature of the webpage, and to suggest a testing action/task for testing the feature. The prompts 200 may be the same for different products, and therefore they may be stored in a non-transitory medium for the first processing unit 150 to retrieve.

In the illustrated example, the prompts 200 also include data, such as the “random” data, that may be different for different product testing. The random data may be a piece of data retrieved from a database storing different types of data for product testing. By means of non-limiting examples, the database may store different first names, different last names, different address, different emails, different phone numbers, etc. During product testing instruction generation, such database may be accessed by the processing units 130, 140, 150 in order to select a piece of data for use in the product testing instruction generation. For example, the first processing unit 130 may retrieve “John” from the list of first names in the database, and may suggest that “Jon” be input in the “first name” field of a webpage. The selection of the data may be performed randomly or may be performed based on certain order or criterion.

In some cases, the prompts 200 provided by the first processing unit 130 may optionally also include information that is specific for the specific product being tested.

FIG. 3C shows an example of the webpage image 202 obtained by the processing unit 130. The first processing unit 130 is configured to provide the prompts 200 of FIGS. 3A-3B and the image 202 of FIG. 3C as input for the neural network 106. The neural network 106 is configured to process the prompts 200 of FIGS. 3A-3B and the webpage image 202 of FIG. 3C, and generate the output 204 of FIG. 3D based on the prompts 200 and the webpage image 202.

As shown in FIG. 3D, the output 204 provided by the neural network 106 is an interpretation of the webpage image, in which the neural network 106 identifies one or more features of the webpage. The output 204 provided by the neural network 106 also includes a suggested testing for the feature(s) of the webpage. In the illustrated embodiments, the neural network 106 characterizes the webpage as being a “form fields” for entering “last name”, “first name”, and “email”. The neural network 106 also suggests filling in the last name field with a certain randomly selected last name as a suggested testing for the form feature of the webpage.

Returning to FIG. 1, after the first processing unit 130 obtains the output 204 from the neural network 106, the first processing unit 130 may then pass the output 204 to the second processing unit 140. In some cases, the first processing unit 130 may process the output 204 from the neural network 106 before passing it to the second processing unit 140. For example, the first processing unit 130 may add one or more prompts, eliminate a part of the output from the neural network 106, select a part of the output 204 from the neural network 106, package a part of the output 204 from the neural network 106 with additional data, or any combination of the foregoing. In other cases, the first processing unit 130 may provide the output 204 from the neural network 106 as an output of the first processing unit 130.

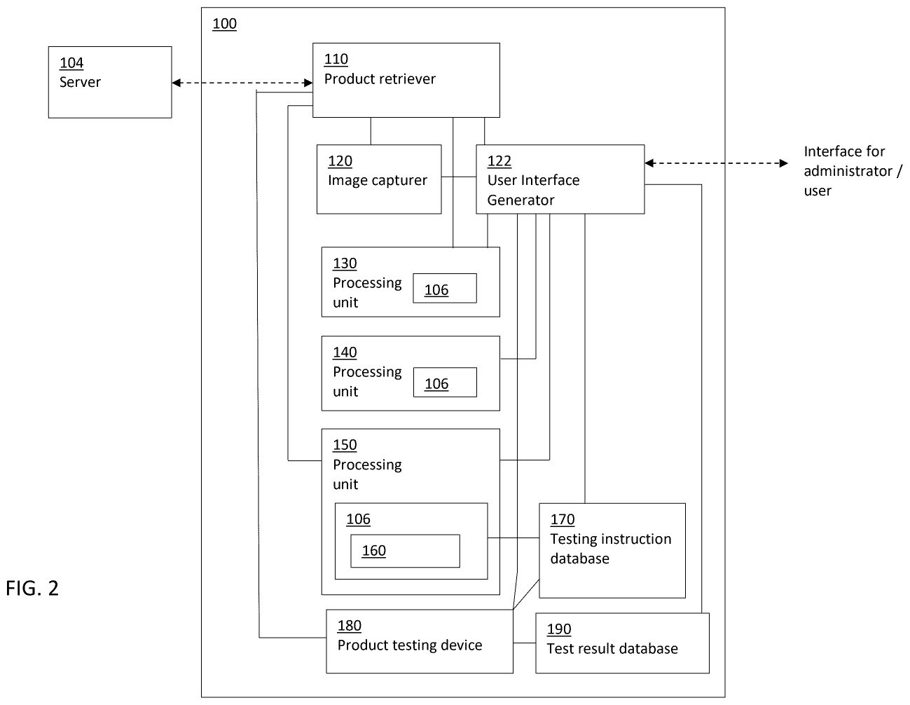

In other embodiments, the output 204 from the neural network 106 may be provided to the second processing unit 140 without going through the first processing unit 130. In further embodiments, at least a part of the neural network 106 may be implemented as a part of the first processing unit 130 (like the embodiments shown in FIG. 2). In such cases, the output 204 from the neural network 106 may be considered as an output of the first agent 130.

### Second Processing Unit

As shown in FIG. 1, the second processing unit 140 is configured to obtain output from the first processing unit 130, and check to determine whether a testing suggestion provided by the first processing unit 130 can be performed. In the illustrated embodiments, the second processing unit 140 is configured to generate prompts, and provide the prompts with an image of the webpage to the neural network 106. The neural network 106 then determines whether an action can be performed on the webpage based on the prompts and the webpage image.

For example, the second processing unit 140 may generate prompts requesting the neural network 106 to determine whether an email address field is present in the webpage image, and whether the email address field is empty so that it is ready to receive email input. As another example, the second processing unit 140 may generate prompts requesting the neural network 106 to determine whether a name field is present in the webpage image, and whether the name field is empty so that it is ready to receive name input. The neural network 106 determines whether the action can be performed on the webpage based on the prompts and the webpage image, and provides an output based on the prompts and the webpage image provided by the second processing unit 140. For example, the neural network 106 may inform the second processing unit 140 that email address field is present, and is available to receive text input in the email address field. As another example, the neural network 106 may inform the second processing unit 140 that the name field is present, and is available to receive text input in the name field.

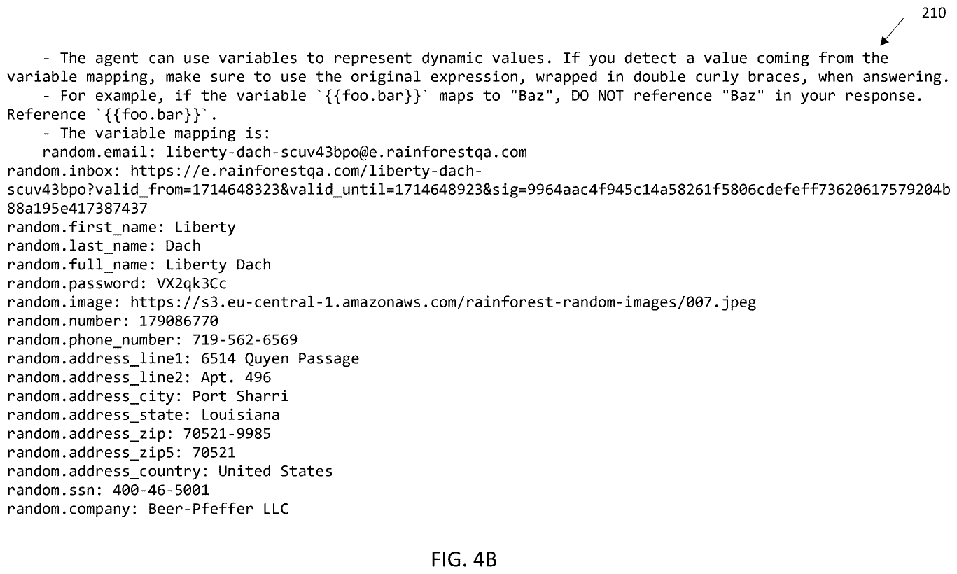

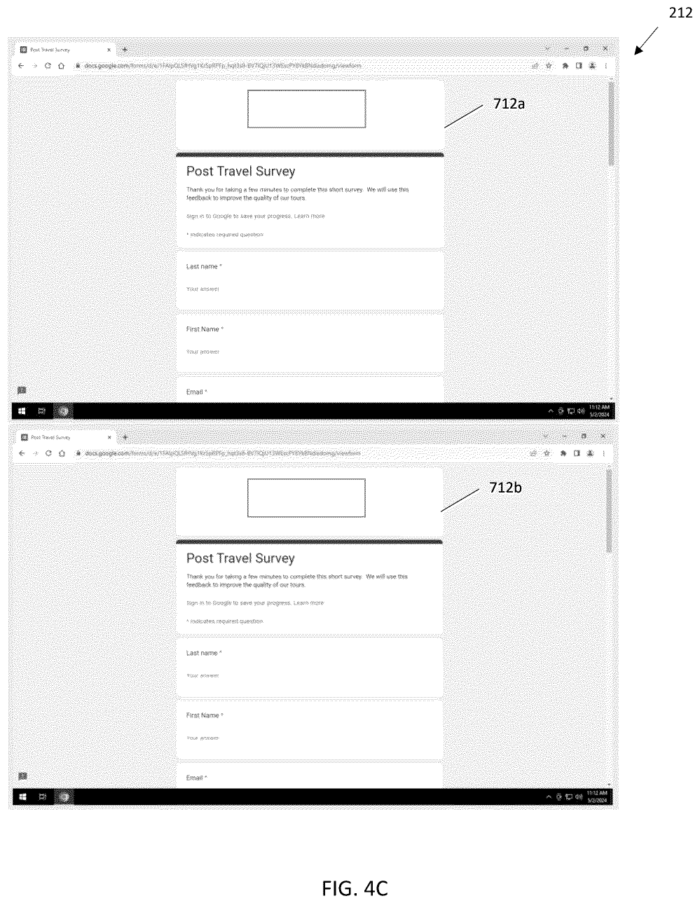

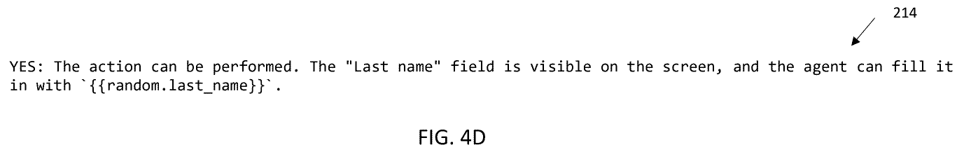

Examples of prompts 210 provided by the second processing unit 140 are shown in FIGS. 4A-4B. The second processing unit 140 may be configured to generate one or more of the prompts 210 automatically. Such prompts 210 may be the same for different products, and therefore they may be stored in a non-transitory medium for the second processing unit 140 to retrieve. The prompts 210 provided by the second processing unit 140 may also include information that is specific for the specific product being tested.

In the illustrated example, the prompts 210 provided by the second processing unit 140 include general instruction for guiding a neural network to provide its output. The general instruction may be the same for different products, and therefore, the second processing unit 140 may automatically create the prompts 210 by retrieving such general instruction from a database. In the illustrated example, the prompts 210 include the following statements that instruct the neural network 106 to check to determine whether a testing action suggested by the first processing unit 130 can be performed:
“You are an assistant helping to verify that an agent can perform certain actions on a web page. You'll be given a description of the action to perform and it's up to you to verify if it's possible to do so. Sometimes the agent infers page elements that aren't visible on the page so always make sure any elements being specified actually exist”,
“You will also be given two screenshots, the first showing what the agent has seen and the second showing the current state of the screen, a few seconds later. No actions were performed between the two times, but the page might've loaded or changed in between.”
“Given the current state of the page is it possible to perform this action?”
“Respond in the following manner:
   If the action can be performed start your response with the text “YES: ”and then explain your reasoning
   If the action cannot be performed start your response with the text “NO: ”and then explain your reasoning”.

In the illustrated example, the prompts 210 also include information that is based on output from the first processing unit 130, and therefore the information is specific for the webpage being tested. As shown in FIGS. 4A-4B, the prompts 210 include the statement “Here is the description of what the agent wants to do: “The form fields for “Last name”, “First Name”, and “Email” are visible on the screen. Fill in the “Last name” field with ‘{{random.last_name}}’.” This information indicates the suggested testing that the first processing unit 130 provides, and along with the rest of the prompts 210, can guide the neural network 106 to provide its output.

FIG. 4C shows an example of the webpage images 212 obtained by the second processing unit 140. In the illustrated example, the second processing unit 140 is configured to obtain two webpage images 712a, 712b for input with the prompts 210 for the neural network 106. The first webpage image 712a is the same webpage image 202 obtained by the first processing unit 130. The second webpage image 712b is a screen shot of a webpage that is obtained after the first webpage image 712a/202 is obtained. It is advantageous to provide multiple images for the neural network 106 to confirm whether a suggested testing is possible. This is because the timing (first time) at which the first processing unit 130 obtains the image 712a/202 of the webpage 202 for input to the neural network 106 (so the neural network 106 can suggest a testing) is different from the timing (second time—which occurs later compared to the first time) at which the second processing unit 140 communicates with the neural network 106 to request the neural network 106 to confirm the suggested testing. Between the first time and the second time, the image of the webpage may have changed, e.g., due to moving graphics, changing graphics, etc. In other embodiments, instead of two webpage images 712a, 712b, the second processing unit 140 may be configured to obtain more than two webpage images (e.g., three, four, five, etc. webpage images), or only one webpage image, for input to the neural network 106. In further embodiments, the second processing unit 140 may be configured to provide a video as input for the neural network 106.

The second processing unit 140 is configured to provide the prompts 210 of FIGS. 4A-4B and the images 712a, 712b of FIG. 4C as input for the neural network 106. The neural network 106 is configured to process the prompts 210 of FIGS. 4A-4B and the webpage images 712a, 712b of FIG. 4C, and generate the output 214 of FIG. 4D based on the prompts 210 and the webpage images 712a, 712b.

As shown in FIG. 4D, the output 214 provided by the neural network 106 includes a confirmation of whether the testing action suggested by the first processing unit 130 can be performed or not. The output 214 provided by the neural network 106 also includes an indication indicating whether certain feature of the webpage is visible, and whether the task and/or details involved in the suggested testing can be performed. In the illustrated embodiments, the neural network 106 confirms that the testing action suggested by the first processing unit 130 “can be performed”. The neural network 106 also indicates that the “last name” field is visible on the screen, and confirms that a randomized last name can be inserted to fill in the last name field.

In some cases, the neural network 106 may determine that the suggested action is not possible to perform (e.g., because the email address field is not present, or because the email address field is not empty). In such cases, after the second processing unit 140 receives the output from the neural network 106 or from the first processing unit 130, the second processing unit 140 may revert back to the first processing unit 130. For example, the second processing unit 140 may provide the output from the neural network 106 to the first processing unit 130 as feedback. In some embodiments in which at least a part of the neural network 106 is implemented as a part of the second processing unit 140, the second processing unit 140 may provide the output from the neural network 106 as an output of the second processing unit 140. For example, the output from the neural network 106 regarding a suggested action that is not possible to perform may be passed from the second processing unit 140 to the first processing unit 130. The first processing unit 130 may again send an image of the webpage along with the same prompt as before—i.e., “Identify a feature of the webpage and the purpose of the feature of the webpage” following the above example. However, this time the first processing unit 130 also provides the feedback (from the second processing unit 140 or from the neural network 106) regarding the suggested action being impossible to perform as input to the neural network 106. The neural network 106 processes the webpage image, the prompt from the first processing unit 30, and also the feedback from the second processing unit 140, and may provide a revised output. For example, the neural network 106 may provide a revised output indicating that the webpage now contains a phone number field, and that the objective of such feature is to allow a user to enter a phone number. The neural network 106 provides such revised output because it now has extra information indicating that the previous suggested action to test the email field cannot be performed. Such “self-healing” feature is advantageous because it allows the electronic system 100 to determine feature-testing objective that is achievable, and to determine product testing instruction that is performable.

If the neural network 106 determines that a suggested product testing task is possible to perform, the second processing unit 140 then provides output to the third processing unit 150, so that the third processing unit 150 can generate product testing instruction based on the output. The output contains information regarding the product testing task that has been confirmed by the neural network 106 as being possible to perform.

### Third Processing Unit

In the embodiments of FIG. 1, the third processing unit 150 is configured to (1) generate prompts for input to the neural network 106, (2) obtain output (e.g., the output 204) from the first processing unit 130, output (e.g., the output 214) from the second processing unit 140, and non-imagery data (e.g., OCR data, DOM data, etc.), and (3) obtain testing instruction based on the prompts, the output from the first processing unit 130, the output from the second processing unit 140, and the non-imagery data.

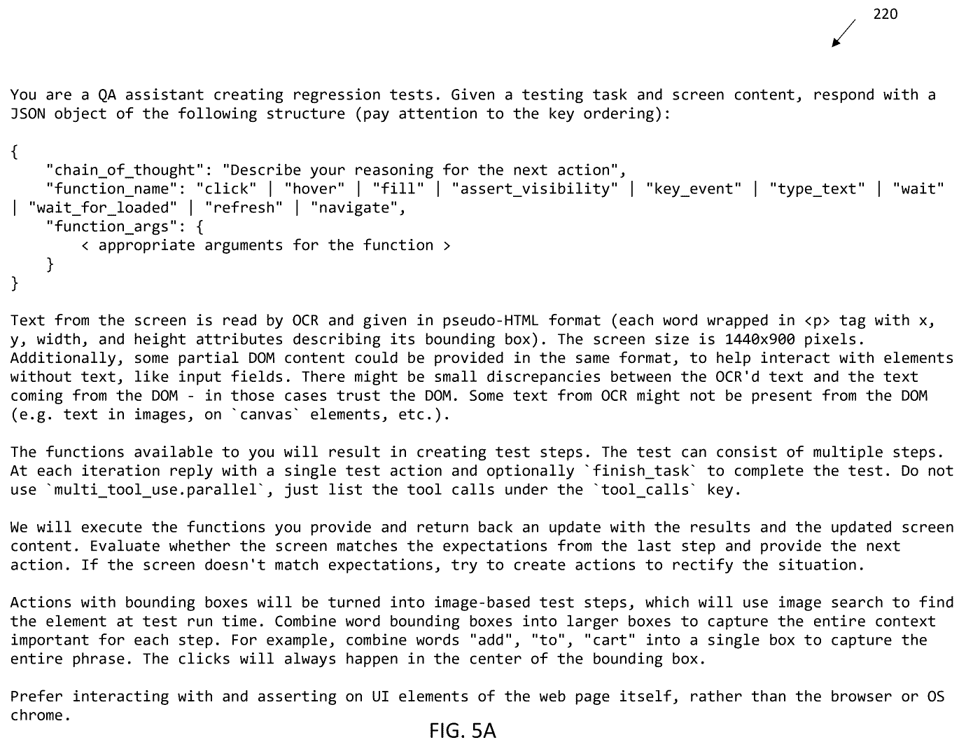

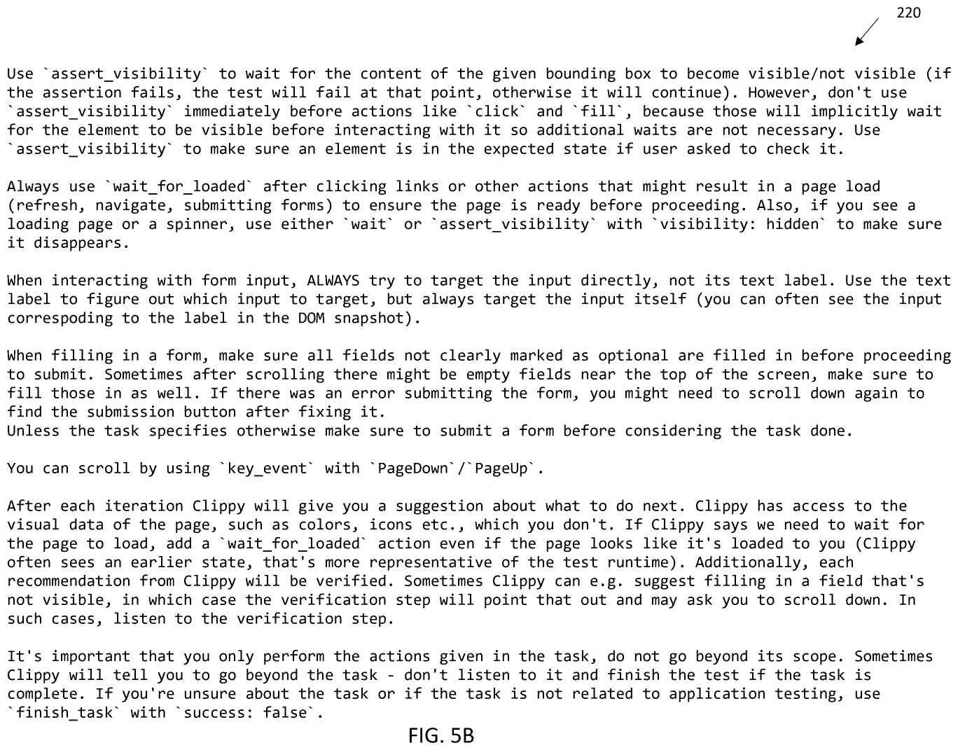

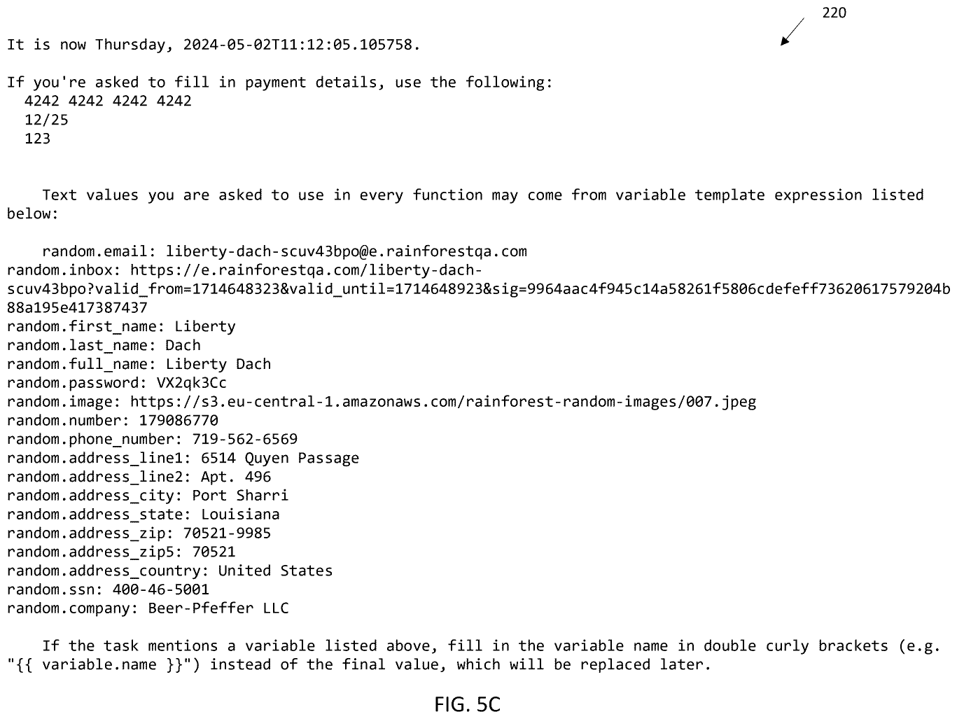

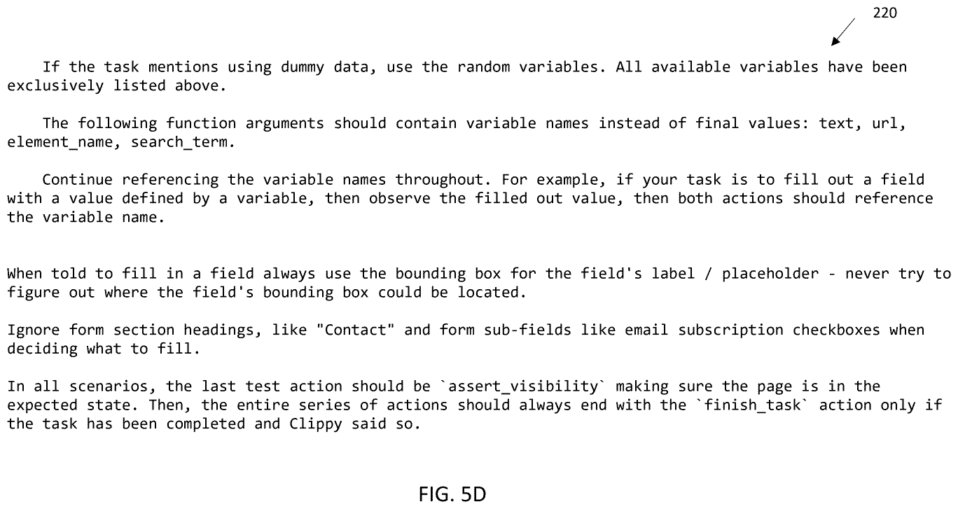

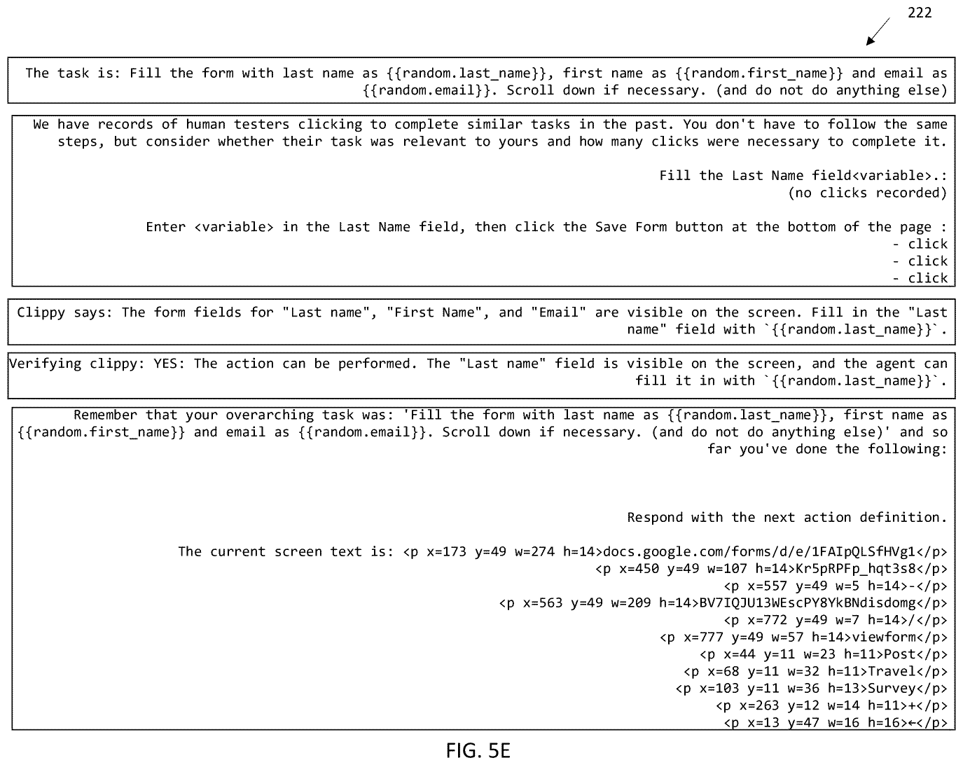

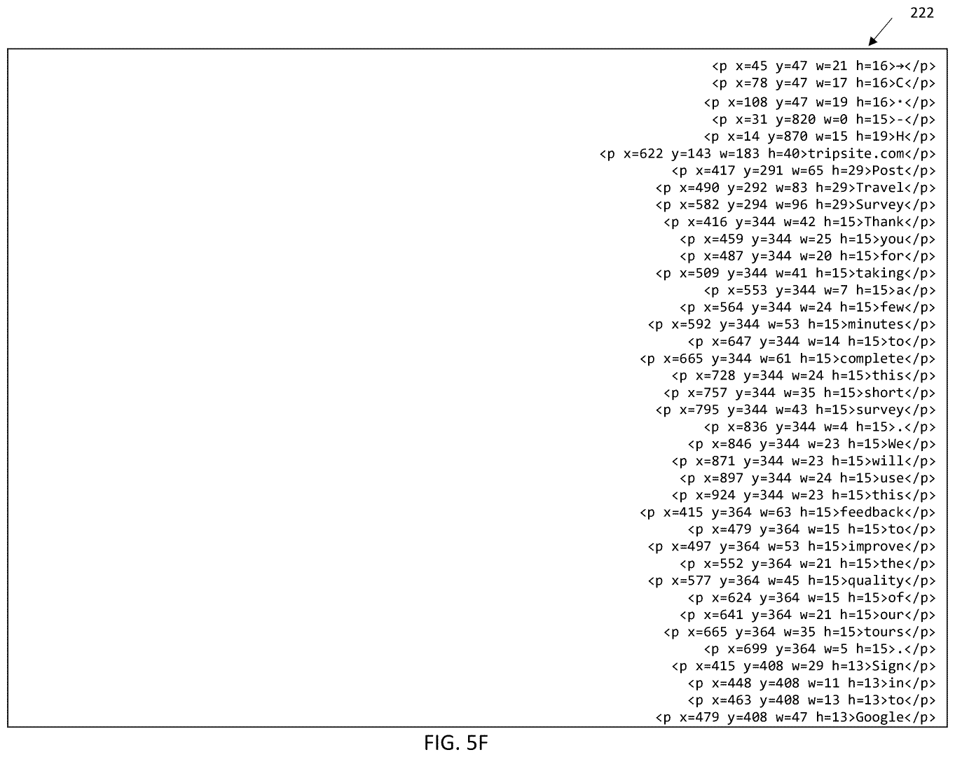

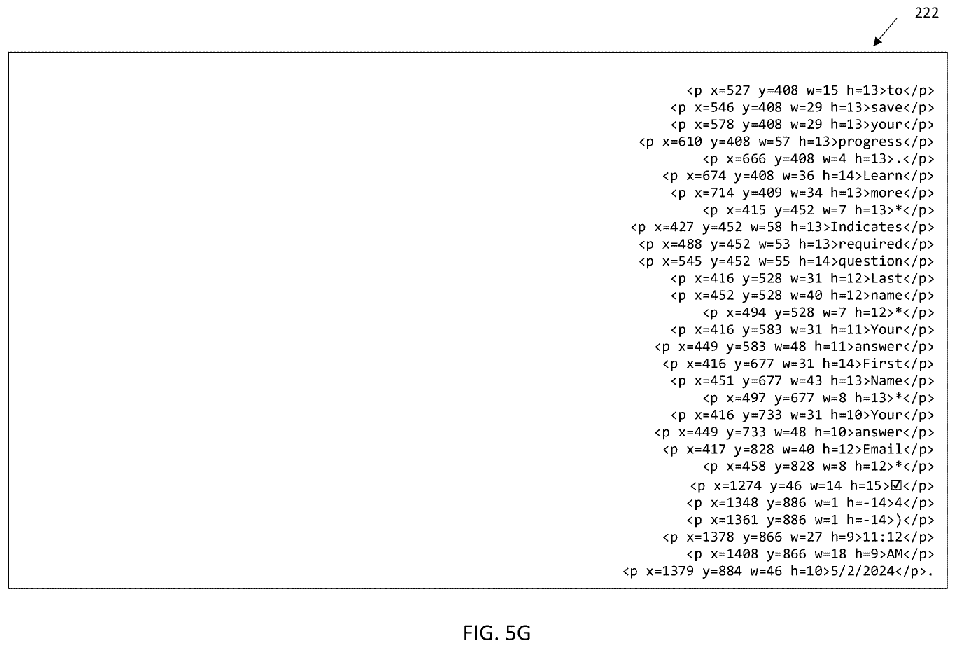

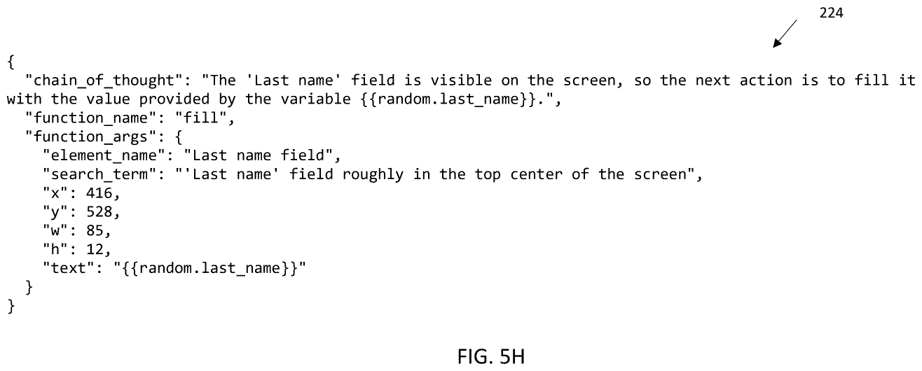

The third processing unit 150 is configured to generate the prompts for guiding the neural network 106 to generate product testing instruction. Examples of prompts 220 provided by the third processing unit 150 are shown in FIGS. 5A-5D. The third processing unit 150 may be configured to generate one or more of the prompts 220 automatically. Such prompts 220 may be the same for different products, and therefore they may be stored in a non-transitory medium for the third processing unit 150 to retrieve. Also, the prompts 220 may inform the neural network 106 the data structure and the programming structure for the product testing instruction, so that the neural network 106 can be guided to provide the proper product testing instruction. The prompts 220 provided by the third processing unit 150 may also include information that is specific for the specific product being tested.

FIGS. 5E-5G shows an example of additional information 222 obtained by the third processing unit 150. The information 222 includes output from the first processing unit 130 and output from the second processing unit 140, which can serve to guide the neural network to generate the proper product testing instruction. In the example shown, the output “The form fields for “Last name”, “First Name”, and “Email” are visible on the screen. Fill in the “Last name” field with ‘{{random.last_name}}“’ from the first processing unit 130 is included as a part of the information 222 packaged by the third processing unit 150 for input to the neural network 106. Also, the output “YES: The action can be performed. The “Last name” field is visible on the screen, and the agent can fill it in with ‘{{random.last_name}}’” from the second processing unit 140 is also included as a part of the information 222 packaged by the third processing unit 150 for input to the neural network 106.

As shown in FIGS. 5E-5F, the information 222 also includes OCR data. In particular, the third processing unit 150 is configured to obtain OCR data, which may contain precise location information of text data in the webpage. The third processing unit 150 may also optionally obtain DOM data if they are available, and may include such data in the information 222.

The third processing unit 150 is configured to provide the prompts 220 of FIGS. 5A-5D and the information 222 of FIGS. 5E-5G as input for the neural network 106. The neural network 106 is configured to process the prompts 220 of FIGS. 5A-5D and the information 222 of FIGS. 5E-5G, and generate the output 204 of FIG. 5H based on the prompts 220 and the information 222.

As shown in FIG. 5H, the output 224 provided by the neural network 106 is a testing instruction (e.g., in the form of a programmed testing instruction). The testing instruction shown in the example contains instruction for causing the product testing device 180 to execute a “fill” function by (1) searching the “last name” field in the “top center of the screen” with coordinate (x=416, y=528) and field dimension of 85×12, and (2) entering “text” obtained from the randomized last name list.

In the illustrated embodiments, because the product testing instruction is generated by the neural network 106, the neural network 106 may be considered as comprising a product testing instruction generator 160. In other embodiments, the product testing instruction generator 160 may be implemented as a part of the third processing unit 150. In further embodiments, the product testing instruction generator 160 may be implemented in both the neural network 106 and the third processing unit 150.

The testing instruction generated by the testing instruction generator 160 is stored in the testing instruction database 170. In some cases, the testing instruction may be stored in a file in association with the product to be tested.

In the illustrated embodiments, the first, second, and third processing units 130, 140, 150 are configured to communicate with the neural network 106. In other embodiments, the first, second, and third processing units 130, 140, 150 may be configured to communicate with different respective neural networks that are different from each other. Also, in other embodiments, the neural network 106 may be considered to be a part of the first processing unit 130, a part of the second processing unit 140, and/or a part of the third processing unit 150. In further embodiments, the processing units 130, 140, 150 may include respective neural networks. Furthermore, in other embodiments, one or more of the processing units 130, 140, 150 may not communicate with any neural network, and/or may not include any neural network.

Although the electronic system 100 has been described as having three processing units 130, 140, 150, in other embodiments, the electronic system 100 may include more than three processing units, or fewer than three processing units (e.g. two processing units, one single processing units). For example, in other embodiments, the first processing unit 130 and the second processing unit 140 may be combined into a single processing unit. In further embodiments, the second processing unit 140 and the third processing unit 150 may be combined into a single processing unit. In still further embodiments, the processing units 130, 140, 150 may be implemented as a single processing unit.

Also, in other embodiments, the electronic system 100 may not include the product testing machine 180 and the test result database 190. In such cases, the electronic system 100 is a test instruction generator configured to generate testing instruction in processor-readable data structure so that the testing instruction can be processed by the product testing machine 180.

As discussed, in other embodiments, the processing units 130, 140, 150 may include respective neural networks. FIG. 2 illustrates a variation of the electronic system 100 of FIG. 1, particularly showing the processing units 130, 140, 150 of the electronic system 100 having their respective neural networks 106. The neural network 106 of the first processing unit 130 is configured to obtain prompts (e.g., the example of the prompts 200 of FIGS. 3A-3B) and webpage image (e.g., the example of the webpage image 202 of FIG. 3C), and generate an output (e.g., the example of the output 204 of FIG. 3D). The first processing unit 130 then transmits the output to the second processing unit 140.

In the embodiments of FIG. 2, the neural network 106 of the second processing unit 140 is configured to obtain prompts (e.g., the example of the prompts 210 of FIGS. 4A-4B) and webpage images (e.g., the examples of the webpage images 712a, 712b of FIG. 4C), and generate an output (e.g., the example of the output 214 of FIG. 4D). The second processing unit 140 then transmits the output to the third processing unit 150.

In the embodiments of FIG. 2, the neural network 106 of the third processing unit 150 is configured to obtain prompts (e.g., the example of the prompts 220 of FIGS. 5A-5D) and information (e.g., the example of the information 222 of FIGS. 5E-5G), and generate an output (e.g., the example of the output 224 of FIG. 5H). The third processing unit 150 then transmits the output to the testing instruction database for storage.

In some cases, the neural network 106 of the first processing unit 130, the neural network 106 of the second processing unit 140, and the neural network 106 of the third processing unit 150 may be different respective neural networks 106. In other cases, the neural network 106 of the first processing unit 130, the neural network 106 of the second processing unit 140, and the neural network 106 of the third processing unit 150 may be the same. For example, in some embodiments, the neural networks 106 of the respective processing units 130, 140, 150 may be implemented by the same neural network. Also, in some embodiments, the neural networks 106 of the respective processing units 130, 140, 150 may be instances of a neural network model. In further embodiments, the neural network 106 may be considered as having one or more neural network models, each of which may be considered as a neural network or a part of a neural network. In some cases, the processing units 130, 140, 150 may be configured to access the neural network models respectively, or may include the respective neural network models as parts of the respective processing units 130, 140, 150.

In some cases, one or more of the processing units 130, 140, 150 may be implemented as one or more prompt generators. For example, a prompt generator may include a first set of prompt generation rules to implement the processing unit 130, a second set of prompt generation rules to implement the processing unit 140, and a third set of prompt generation rules to implement the processing unit 150. The prompt generation rules may prescribes certain word(s), phrase(s), sentence(s), question(s), equation(s), data, number(s), or any information be retrieved from a database, and be organized in certain manner to form an input prompt for the neural network 106. Depending on the stage of the testing, different rules may be applied to create different prompts. Also, in some cases, a prompt generation rule may prescribe that a previous neural network output be obtained and be included as a part of a prompt. Examples of prompts 200 generated by the prompt generator (processing unit 130) based on the first set of prompt generation rules were described with reference to FIGS. 3A-3B. Examples of prompts 210 generated by the prompt generator (processing unit 140) based on the second set of prompt generation rules were described with reference to FIGS. 4A-4B. Examples of prompts 220 generated by the prompt generator (processing unit 150) based on the third set of prompt generation rules were described with reference to FIGS. 5A-5D. The prompt generator may operate based on prompt engineering principles. In some embodiments, the first set of prompt generation rules may be configured to implement a first role (e.g., testing suggester) for the neural network 106, the second set of prompt generation rules may be configured to implement a second role (e.g., suggested testing confirmer) for the neural network 106, and the third set of prompt generation rules may be configured to implement a third role (e.g., testing instruction generator) for the neural network 106. One or more of the prompt generators may be implemented using hardware, software, or a combination of hardware and software.

Also, in some embodiments, any of the components of the electronic system 100 may be implemented using hardware, software, or a combination of hardware and software. For example, each of the items below may be implemented using a hardware, software, or a combination of both: product retriever 110, image capturer 120, user interface generator 122, processing unit 130, processing unit 140, processing unit 150, testing instruction generator 160, testing instruction database, product testing device 180, test result database, neural network 106, server 104.

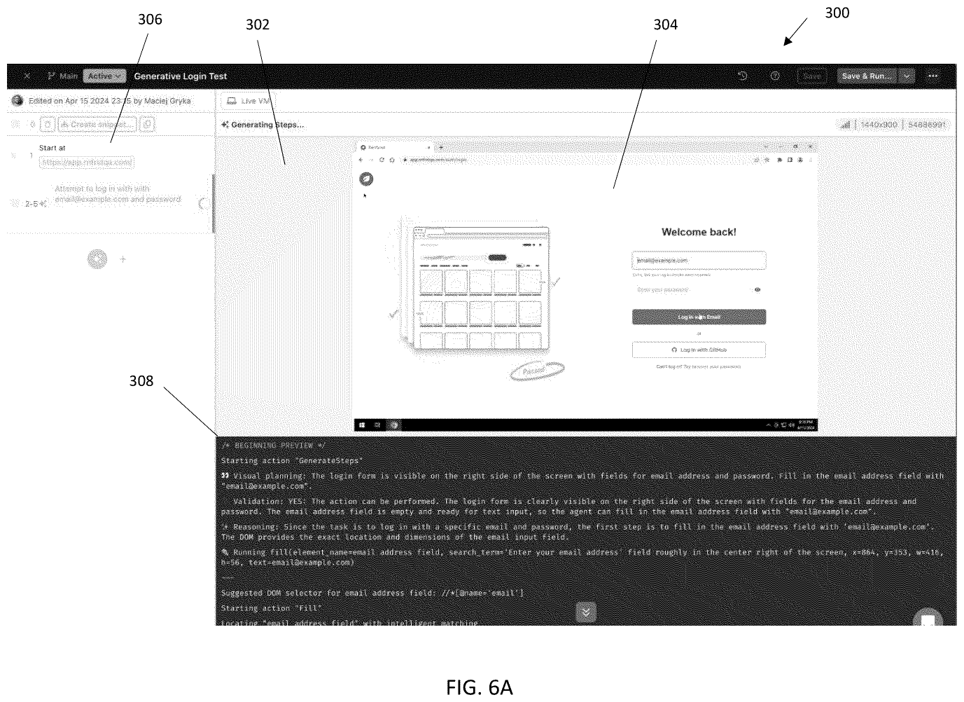

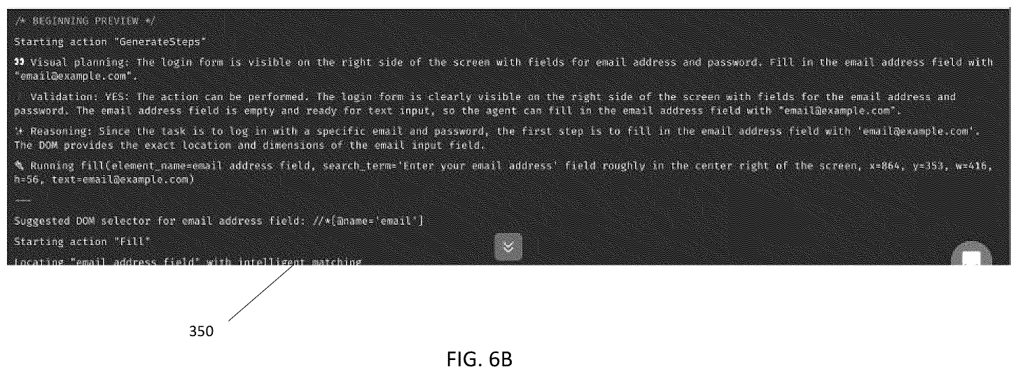

In some embodiments, the electronic system 100 may provide a user interface for allowing a user to view output of the processing units 130, 140, 150, monitor a progress of testing instruction generation, review testing instruction that has been automatically generated by the electronic system 100, or two or more of the foregoing. FIG. 6A illustrates a user interface 300 provided by the electronic system 100. In some cases, the user interface 300 may be provided by the user interface generator 122 of the electronic system 100. The user interface 300 includes a first section 302 for displaying an image 304 of the webpage for product testing. The user interface 300 also includes a second section 306 for presenting product testing instruction that has been generated automatically so far by the electronic system 100. The user interface 300 also includes a third section 308 showing the output provided by the processing units 130, 140, 150. FIG. 6B illustrates a close-up view of the third section 308 of the user interface of FIG. 6A, showing the output 350 of the processing units 130, 140, 150. As shown in the figure, the processing unit 130 is configured to provide “visual planning”, and provides an output indicating that the webpage has a login form that is visible, and an email address field on the right side of the screen. The processing unit 130 also suggests the testing task of filling in the email address field with “email@example.com”. Also, the processing unit 140 is configured to provide validation to confirm whether the suggested testing task can be performed. As shown in the output 350 of FIG. 6B, the processing unit 140 provides an output indicating that the action can be performed. The output 350 also includes product testing instruction “Running fill (element . . . )” output by the third processing unit 150.

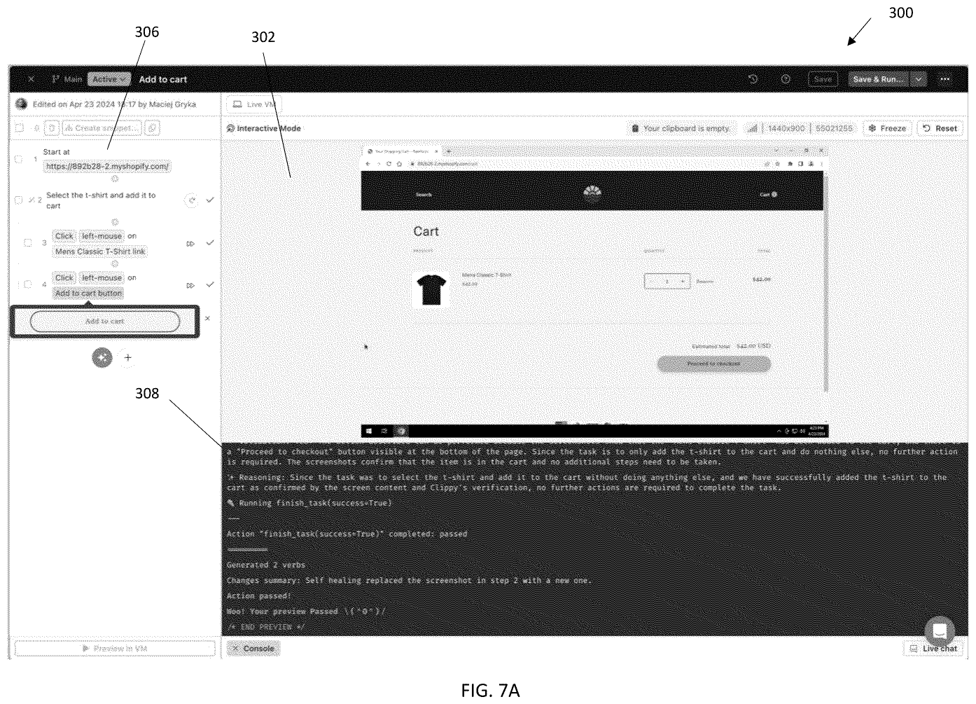

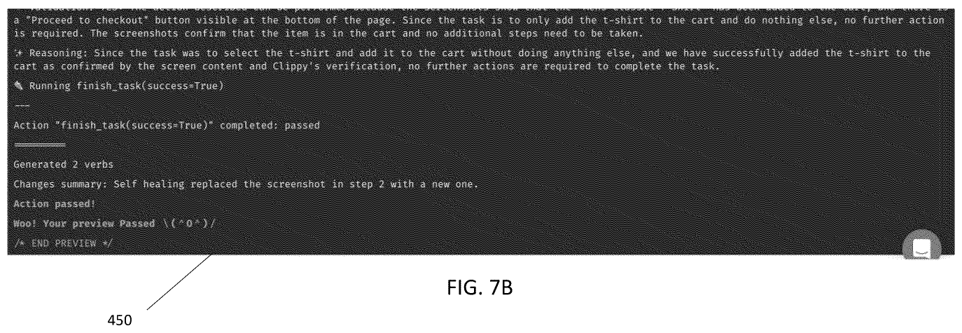

FIG. 7A illustrates another example of content provided by the user interface 300, particularly showing the electronic system 100 suggesting a testing for another feature of a product, verifying that the suggested testing can be performed, and generating product testing instruction to test the other feature of the product. FIG. 7B illustrates a close-up view of a part of the user interface of FIG. 7A, showing the output 450 of the processing units 130, 140, 150. As shown in FIGS. 7A-7B, the top part is the “chain of thought” provided by one or more agent(s) (e.g., processing units 130, 140, 150, and/or neural network(s), such as neural network 106). The bottom part shows a summary of what happened in this testing instruction generation “session” (in the example, two actions were generated, and the system executed them successfully). The “changes summary” indicates what has changed from the last instruction generation. In the example, some actions existed already, and now the user has clicked “generate” again, and the system updated the screenshot in the second action.

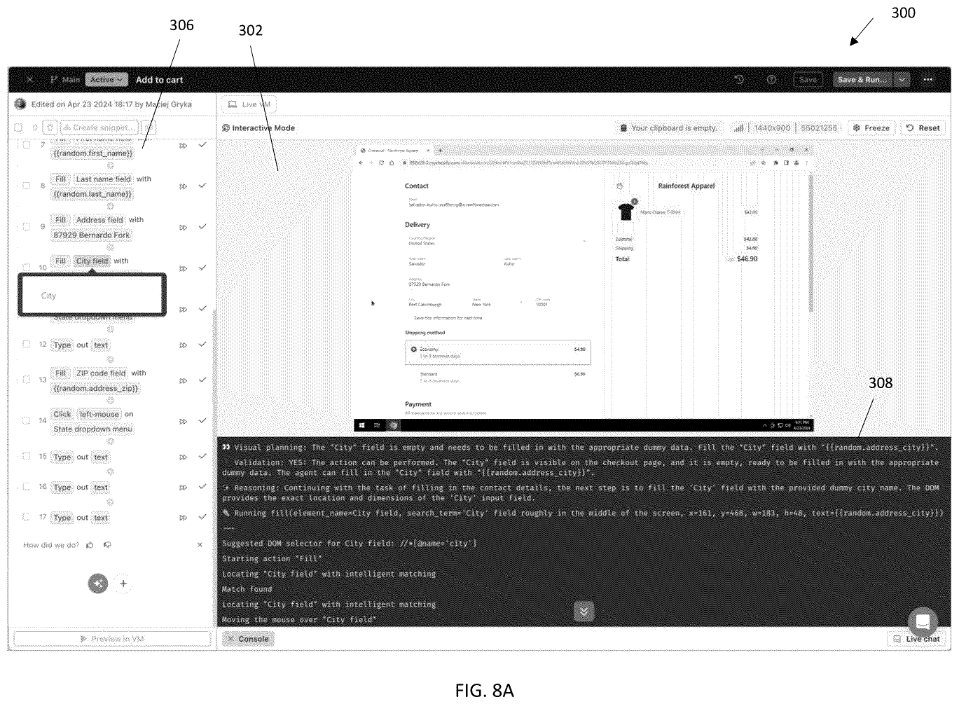

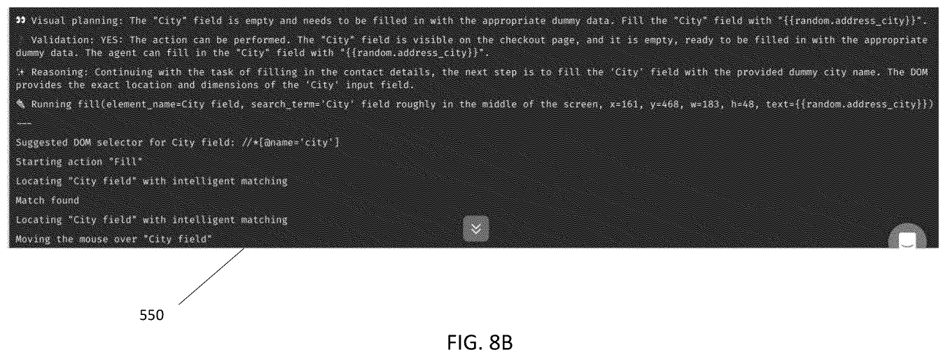

FIG. 8A illustrates another example of content provided by the user interface 300, particularly showing the electronic system 100 suggesting a testing for another feature of a product, verifying that the suggested testing can be performed, and generating product testing instruction to test the other feature of the product. FIG. 8B illustrates a close-up view of a part of the user interface of FIG. 8A, showing the output 550 of the processing units 130, 140, 150. The output shown in the example of FIGS. 8A-8B is a “user-friendly” version of the reasoning provided by agent(s) (e.g., one or more processing units 130, 140, 150 and/or neural network(s), such as neural network 106). For every decision that an agent makes, the agent also provides its reasoning for the decision. For example, in addition to the agent suggesting to “click on this button”, the agent may also provide its reasoning as follows: “the task is to click on button X, I can see button that looks like X at coordinates Y, so the next step is to click on coordinates Y”. In one implementation, a processing unit (e.g., processing unit 130/140/150) may be configured to provide the prompt “talking through it” to the neural network 106 so that the neural network 106 can provide an action suggestion and also a reasoning for the suggested action. In some cases, the system 100 and/or an administrator may perform light editing (e.g., via a user interface) of some of this reasoning, and then the system 100 may provide it to the user because it helps the user understand what is happening behind the scenes.

In some embodiments, the electronic system 100 may be configured to perform a process to determine product testing instructions to test multiple different features of the product (e.g., the website in the example). In such cases, after the processing units 130 140, 150 are utilized the first time to generate the product testing instruction to test a certain feature of the product, the product testing device 180 of the electronic system 100 may execute the product testing instruction in order to determine the next feature of the website to be tested. For example, after the product testing device 180 executes the product testing instruction to fill in an email address field, and click “submit”, the website may present a new webpage with a set of different features. The electronic system 100 then utilize the processing units 130, 140, 150 again (the second time) to generate product testing instruction to test a feature of the new webpage. The above process is repeated until a super-set of product testing instructions have been generated to test all desired features of the website. The super-set of the product testing instructions may be stored in the testing instruction database 170, so that it can be used by the product testing device 180 to test the website in the future. Thus, as illustrated in the above example, in order to test a product (e.g., a website), the generated product testing instruction will need to be executed at least two times. In the first time, the product testing instruction is executed (while the electronic system 100 is in the process of obtaining the super-set of instructions) so that the electronic system 100 can discover additional features of the website to be tested. In the second time, the product testing instruction is executed together with other product testing instruction in the super-set in order to test all the desired features of the product. The results of the testing may be stored in the test result database 190. The testing results may be accessed by the user interface provided by the user interface generator 122, which may be configured to retrieve test results from the test result database 190.

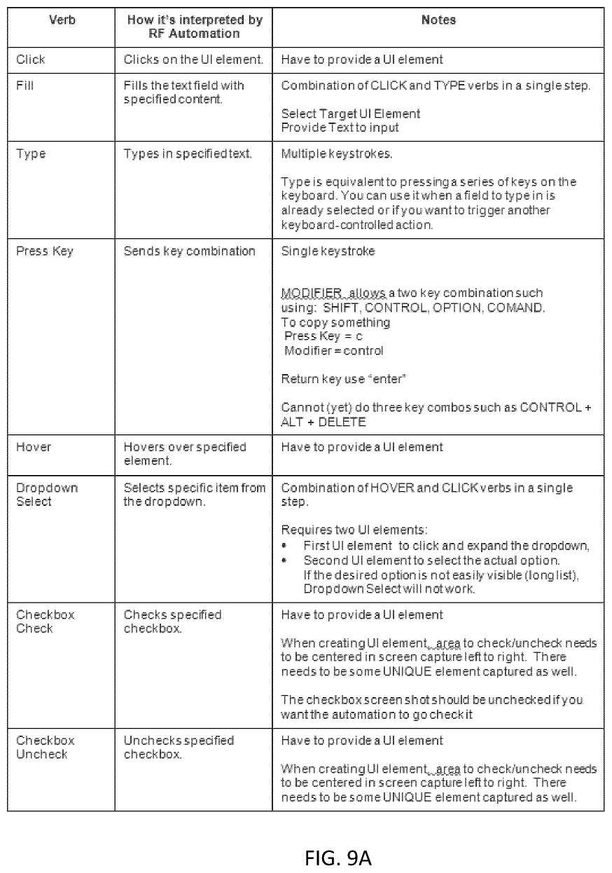

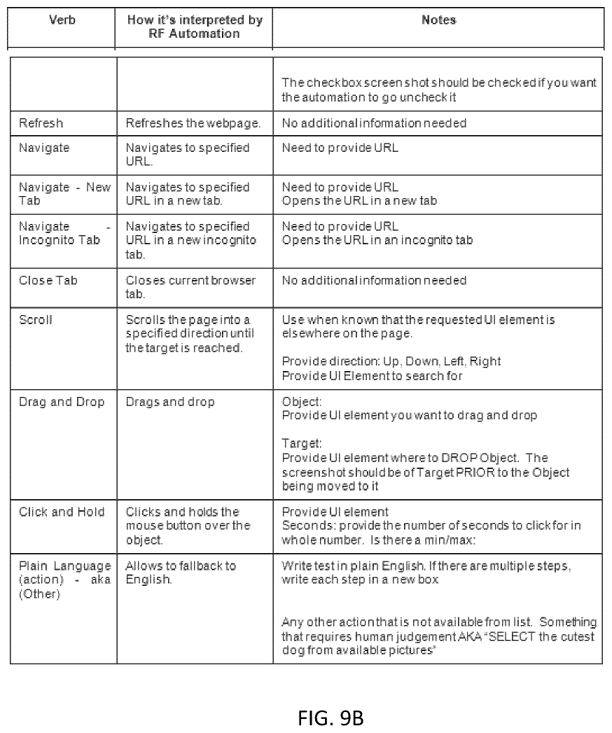

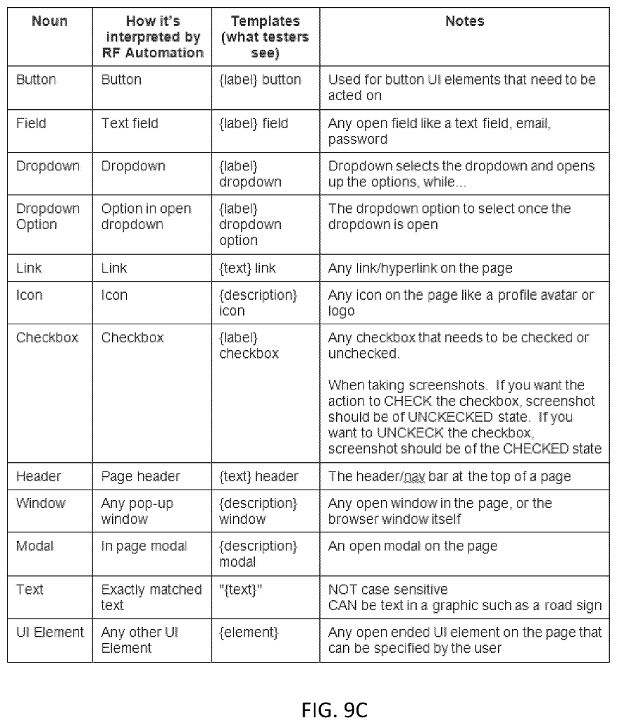

In some embodiments, the testing instruction generator 160 may be configured to generate product testing instruction based on one or more action identifiers. FIGS. 9A-9B illustrate examples of action identifiers that may be provided by the electronic system 100 for allowing the testing instruction generator 160 to select in order to generate product testing instruction. In particular, the leftmost column of the table in FIGS. 9A-9B shows examples of a first list of items, which are action identifiers. The examples of the action identifiers are for a click action, a fill action, a type action, a press key action, a hover action, a dropdown select action, a checkbox check action, a checkbox uncheck action, a refresh action, a navigate action, a new tab action, a close tab action, a scroll cation, a drag and drop action, and a click and hold action. The middle column of the table in FIGS. 9A-9B describes the actions performed by the product testing device for the respective action identifiers. The rightmost column of the table provides some information regarding the use of the respective action identifiers. For example, for the “click” action identifier, it is indicated that use of such action identifier would require an identification of a user interface element (e.g., button, icon, tab, etc.), so that when the product testing device processes such command, the product testing device will know what element to click on. The user interface elements on which the actions are to be performed by the product testing device is not limited to the above examples. FIG. 9C illustrates examples of object identifiers that may be provided by the electronic system 100 for selection by the product instruction generator 160 in order to generate the product testing instruction. In particular, the leftmost column of the table in FIG. 9C shows examples of a second list of items, which are object identifiers for identifying objects such as user interface elements. The examples of the object identifiers are for a button, a field, a dropdown menu, a dropdown option, a link, an icon, a checkbox, a header, a window, a text, a modal, and other user interface element.

As discussed, in some embodiments, the testing instruction generator 160 may be implemented using the neural network 106. In such cases, action identifiers and object identifiers described herein may be provided for the neural network, and pre-defined rules for generating testing instruction may also be provided to the neural network. Based on the suggested and confirmed testing, and based on the pre-defined rules for generating testing instruction using the action identifiers and object identifiers, the neural network may automatically generate the product testing instruction (e.g., the output 224 of FIG. 5H). Thus, in some embodiments, the testing instruction generator 160 may be implemented as a part of the neural network 106.

In other embodiments, the testing instruction generator 160 may be a part of the third processing unit 150. In further embodiments, the testing instruction generator 160 may be separate from the third processing unit 150, and is not a part of the third processing unit 150. In such cases, the third processing unit 150 may communicate with the testing instruction generator 160. Also, in some embodiments, the testing instruction generator 160 may be a non-neural-network entity, which is configured to generate product testing instruction based on pre-defined rules.

In some embodiments, the user interface generator 122 may provide a user interface that allows a user to create product testing instruction by entering user inputs. The product testing instruction created by the user may be combined with the product testing instruction automatically generated by the electronic system 100. The user interface may provide action identifiers like those shown in FIGS. 9A-9B and object identifiers like those shown in FIG. 9C, for allowing the user to select in order to create the product testing instruction. In some embodiments, the list of action identifiers and the list of object identifiers may be provided by the user interface as selectable objects. In other embodiments, the user interface may provide a region for allowing the user to write commands using the action identifiers and the object identifiers (e.g., by typing them). Also, in some embodiments, the user may write the product testing instruction in plain language, and the electronic system 100 may include an interpreter configured to interpret the plain language, and to convert the plain language to programming language (product testing language), and vice versa.

In some embodiments, the user interface provided by the user interface generator 122 comprises a graphical user interface. The graphical user interface may provide a first set of items and a second set of items for user-selection, wherein the first set of items comprises a plurality of action identifiers, and the second set of items comprises a plurality of object identifiers. An action identifier may identify an action to be performed by the product testing device 180, and an object identifier may identify an object on which the action is to be performed by the product testing device 180. By means of non-limiting examples, an action identifier may identify a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action. Also, by means of non-limiting examples, an object identifier may identify a button, a field, a dropdown menu, a dropdown option, a link, an icon, a checkbox, a header, a window, a text, a modal, or an user interface element.

After the product testing instruction has been generated by the electronic system 100, the product testing instruction is then saved in an electronic file in the testing instruction database 170. In some embodiments, each electronic file includes product testing instruction for testing a feature of the product. In other embodiments, each electronic file may include product testing instruction for testing multiple features of the product. The testing instruction stored in the database 170 is a programmed testing instruction in the sense that it is created using pre-defined words (e.g., commands) such as action identifiers and object identifiers described herein. These pre-defined words are organized by the testing instruction generator 160 according to pre-defined programming rules and data structure, and collectively form a programming language that is unique and specific for product testing.

In some embodiments, the product testing instruction in the electronic file has a data structure that associates an action identifier with a corresponding object identifier: The action identifier identifies an action to be performed by the product testing device 180, and the object identifier identifies an object on which the action is to be performed by the product testing device 180.

Also, in some embodiments, the testing instruction database 170 may be configured to store the electronic file (with the product testing instruction) in association with an identity of the product. The testing instruction database 170 may be one or more non-transitory mediums.

In the illustrated embodiments, the electronic file in the database 170 may be retrieved by the product testing device 180, which executes the testing instruction in the electronic file to perform product testing of a product. In the illustrated embodiments, the product testing device 180 is configured to understand and interpret the testing instruction in the electronic file. In particular, the product testing device 180 includes a processing unit that is configured (e.g., designed, built, and/or programmed) to identify pre-determined words, such as action identifiers and object identifiers, which are unique and specific for product testing. Because the testing instruction is structured in a way that follows a flow sequence of human actions when interacting with the product, when the product testing device 180 performs automated product testing on the product based on the testing instruction, the product testing device 180 simulates the flow sequence of human actions to interact with the product. For examples, the processing unit of the product testing deice 180 may be configured to move a cursor without input from a cursor control, make a selection of an object without input from a cursor control, type a text in a field without input from a keyboard, etc., or any combination of the foregoing.

Also, in some embodiments, the processing unit of the product testing device 180 may include an interpreter configured to interpret the product testing instruction in the electronic file. In one implementation, the interpreter is configured to identify pre-defined words (e.g., commands) such as action identifiers and object identifiers, and the processing unit of the product testing device 180 then executes a corresponding function or routine to perform a task to test the product based on the interpreted words. The processing unit of the product testing device 180 may include a selector that is configured to select the function or routine based on a map (e.g., a table) that maps or associates pre-defined words with respective functions or routines.

In other embodiments, the electronic system 100 may include a script generator configured to generate a script based on the product testing instruction in the electronic file. In such cases, the processing unit of the product testing device 180 is configured to run the script for testing the product.

In some embodiments, the processing unit of the product testing device 180 is configured to test multiple features of the product based on the product testing instruction in the electronic file. In such cases, the electronic file may contain product testing instruction configured to cause the product testing device 180 to perform multiple tasks for testing the multiple features. In other embodiments, the processing unit of the product testing device 180 may be configured to test different features of the product based on different product testing instruction in different respective electronic files. For example, the processing unit of the product testing device 180 may be configured to test a first feature of the product based on the product testing instruction in a first electronic file, and to test a second feature of the product based on product testing instruction in a second electronic file.

In some embodiments, the product testing device 180 may include a checker configured to check if an element is visible after the processing unit of the product testing device 180 performs a testing action. In the embodiments in which the product is a website or has a user interface, the element may be any user interface element, such as an icon, an button, a tab, a link, a graphic, etc. Also, in some embodiments, the checker of the product testing device 180 may be configured to check if an element is not visible after the processing unit of the product testing device 180 performs a testing action. The checker of the product testing device 180 may also be configured to check if a specified page has loaded after the processing unit performs a testing action.

In some cases, the processing unit of the product testing device 180 may implement the checker. Also, in some embodiments, the processing unit of the product testing device 180 may be configured to check whether an item exists or not in a user interface of the product by: obtaining a first image that is associated with the testing of the product, obtaining a second image, and comparing the first and second images to determine if there is a match or not. The first image is based on a completion of a first task performed during the testing of the product. For example, the first image may comprise a first content of the product, the first content indicating a first result of a first task for testing the product. The second image may be a reference image that was obtained previously (e.g., via screen capture).

The product testing device 180 is not limited to checking whether an object (e.g., a user interface element of a product) exists. In other embodiments, the product testing device 180 may be configured to provide other types of checks. For example, in other embodiments, the product testing device 180 may be configured to determine if an object (e.g., a user interface element of a product) disappears or not. In one implementation, if the product testing device 180 cannot find a 100% pixel match between an image of the product and the image of the object provided in the product testing instruction, then the product testing device 180 may determine that the object has disappeared.

As another example, the product testing device 180 may check to see if a specified page has loaded or not. In one implementation, the product testing device 180 may pause the execution of testing instruction, and may wait for a page to load. Once a page has been loaded, the product testing device 1080 may then compare the loaded page with an object (e.g., an image of the page, or an image of a part of the page) input in the testing instruction. If there is a match, then the product testing device 180 may determine that the page has loaded. In some cases, if a page has a changing element (e.g., a movie, an animated GIF, etc.), or if a page does not fully load, the product testing device 180 may wait for a prescribed duration (e.g., 30 seconds). After the prescribed duration has lapsed, the product testing device 180 will then continue executing the product testing instruction and moves to the next product testing task.

In another example, the product testing device 180 may be configured to check to see if a certain text exists in a page. In one implementation, the product testing device 180 may perform a word search in a page to look for a certain text. The text may be a word, a symbol, a number, etc. Also, in some embodiments, the product testing device 180 may be configured to check to see if a certain number in a page is equal to a value, less than a value, or more than a value. In other embodiments, the product testing device 180 may be configured to check to see if a list in a page is sorted alphabetically or numerically.

As illustrated in the above embodiments and examples, the electronic system 100 is advantageous because it allows testing instruction to be generated automatically using neural network 106. The automatic testing instruction generation described herein also obviates the need for user to write script or to write complex coding language, thereby saving tremendous time, resources, and man-power. Also, the “confirmation” feature (in which a suggested testing is confirmed by a processing unit as being able to be performed) provided by the electronic system 100 is advantageous because it eliminates or substantially reduces error in the automatic testing instruction generation. This ensures that the generated testing instruction can indeed be carried out by the product testing device 180 to test an intended feature of the product. After product testing instruction has been created by the testing instruction generator 160, the product testing instruction may be executed one or more times to test a product without using human tester. The product testing instruction may also be executed repeatedly to test different versions of a product. The “self-healing” feature provided the electronic system 100 described herein will allow the electronic system 100 to make changes to the product testing instruction automatically even if there is a change to an existing product (e.g., for a new version of the product). Accordingly, the electronic system 100 produces a real and concrete utility that makes a difference in the physical world.

Although the above embodiments have been described with reference to testing a product that is a web page or a web site, in other embodiments, the system and method described herein may be applied to test other products. By means of non-limiting examples, the product may be any software (e.g., application), any hardware, any physical device, or any computer modeling.

### Method

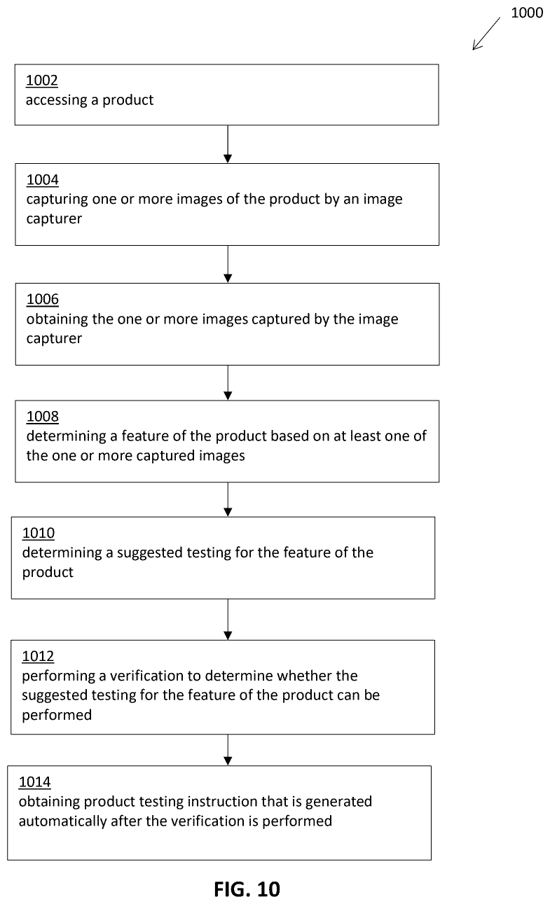

FIG. 10 illustrates a method 1000 performed by an electronic system, such as the electronic system 100 of FIG. 1. The method 1000 includes: accessing a product; capturing one or more images of the product by an image capturer; obtaining the one or more images captured by the image capturer; determining a feature of the product based on at least one of the one or more captured images; suggesting a testing for the feature of the product; performing a verification to determine whether the suggested testing for the feature of the product can be performed; and obtaining product testing instruction after the verification is performed.

In some embodiments, the method 1000 may be performed in response to a processing unit processing a set of instructions stored in a processor-readable medium. In particular, the processor-readable medium includes a set of instructions, wherein an execution of the instructions by a processing unit will cause a method to be performed, the method comprising: accessing a product; capturing one or more images of the product by an image capturer; obtaining the one or more images captured by the image capturer; determining a feature of the product based on at least one of the one or more captured images; suggesting a testing for the feature of the product; performing a verification to determine whether the suggested testing for the feature of the product can be performed; and obtaining product testing instruction that is generated automatically after the verification is performed.

Optionally, in the method 1000, the feature of the product is determined by a first processing unit of the electronic system based on the at least one of the one or more captured images.

Optionally, in the method 1000, the feature of the product is determined by the first processing unit utilizing a first neural network.

Optionally, in the method 1000, the feature of the product is determined by the first processing unit accessing the first neural network.

Optionally, in the method 1000, the first neural network is a part of the first processing unit.

Optionally, in the method 1000, the first neural network comprises ChatGPT.

Optionally, in the method 1000, the verification is performed by a second processing unit to determine whether the suggested testing for the feature of the product can be performed.

Optionally, in the method 1000, the verification is performed by the second processing unit utilizing the first neural network to determine whether the suggested testing for the feature of the product can be performed.

Optionally, in the method 1000, the verification is performed by the second processing unit to determine whether the suggested testing for the feature of the product can be performed by accessing the first neural network.

Optionally, in the method 1000, the first neural network is a part of the first processing unit, and a part of the second processing unit.

Optionally, in the method 1000, the verification is performed by the second processing unit utilizing a second neural network to determine whether the suggested testing for the feature of the product can be performed.

Optionally, the method 1000 further includes providing feedback, by the second processing unit, to the first processing unit if the second processing unit determines that the suggested testing for the feature of the product cannot be performed.

Optionally, the method 1000 further includes determining by the first processing unit another feature of the product, and/or suggesting by the first processing unit another testing based on the feedback, utilizing the first neural network.

Optionally, in the method 1000, the product testing instruction is generated by a testing instruction generator that is a part of a third processing unit, or a part of a neural network.

Optionally, the method 1000, further includes receiving, by the third processing unit, an input from the second processing unit.

Optionally, the method 1000 further includes obtaining OCR data and DOM data by the third processing unit, wherein the product testing instruction is generated based on at least a part of the OCR data and at least a part of the DOM data.

Optionally, in the method 1000, the first processing unit, the second processing unit, and the third processing unit are configured to access the first neural network.

Optionally, in the method 1000, the first neural network forms a part of the first processing unit, a part of the second processing unit, and a part of the third processing unit.

Optionally, the method 1000 further includes executing the product testing instruction, by a product testing device, to perform testing of the product based on the product testing instruction.

Optionally, in the method 1000, the product testing instruction is executed to move a cursor without input from a cursor control.

Optionally, in the method 1000, the product testing instruction is executed to make a selection of an object without input from a cursor control.

Optionally, in the method 1000, the product testing instruction is executed to insert a text in a field without input from a keyboard.

Optionally, in the method 1000, the product testing instruction is executed by the product testing device to interpret the product testing instruction.

Optionally, the method 1000 further includes accessing, by a product testing instruction generator, a first set of items and a second set of items, wherein the first set of items comprises a plurality of action identifiers, and the second set of items comprises a plurality of objects.

Optionally, in the method 1000, one of the action identifiers identifies an action to be performed by the product testing device, and one of the object identifiers identifies an object on which the action is to be performed by the product testing device.

Optionally, in the method 1000, one of the action identifiers identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

Optionally, in the method 1000, one of the object identifiers identifies a button, a field, a dropdown menu, a dropdown option, a link, an icon, a checkbox, a header, a window, a text, a modal, or an user interface element.

Optionally, in the method 1000, the product testing instruction has a data structure that associates an action identifier with a corresponding object identifier:

Optionally, in the method 1000, the action identifier identifies an action to be performed by the product testing device, and the object identifier identifies an object on which the action is to be performed by the product testing device.

Optionally, in the method 1000, the action identifier identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

Optionally, in the method 1000, the object identifier identifies a button, a field, a dropdown menu, a dropdown option, a link, an icon, a checkbox, a header, a window, a text, a modal, or an user interface element.

Optionally, the method 1000 further includes storing the product testing instruction in a non-transitory medium in association with an identity of the product.

Optionally, the method 1000 further includes checking, by the product testing device, if an element is visible after the product testing device performs a testing action.

Optionally, the method 1000 further includes checking, by the product testing device, if an element is not visible after the product testing device performs a testing action.

Optionally, the method 1000 further includes checking, by the product testing device, if a specified page has loaded after the product testing device performs a testing action.

Optionally, the method 1000 further includes: obtaining a first image that is associated with the testing of the product, obtaining a second image, the second image being a reference image that is pre-determined before the first image is obtained, performing a comparison based on the first image and the second image, and determining whether the product passes or fails a product testing task based on a result of the comparison.

Optionally, in the method 1000, the first image is based on a completion of the product testing task performed during the testing of the product.

Optionally, in the method 1000, the product comprises a web page, a web site, a computer application, a mobile device application, or a processor application.

Optionally, in the method 1000, the product testing device is configured to perform machine-based testing of the product.

Optionally, in the method 1000, the act of determining the feature of the product, the act of suggesting the testing for the feature of the product, and the act of performing the verification to determine whether the suggested testing for the feature of the product can be performed, are performed by one or more neural networks that receive prompts from a prompt generator.

Optionally, the method 1000 further includes: obtaining past testing information regarding past human-testing action and/or past machine-testing action, and providing the past testing information to one or more processing units of the electronic system for guiding an operation of the one or more processing units.

In some embodiments, the set of instructions includes: instruction for accessing a product; capturing one or more images of the product by an image capturer; instruction for obtaining the one or more images captured by the image capturer; instruction for determining a feature of the product based on at least one of the one or more captured images; instruction for suggesting a testing for the feature of the product; instruction for performing a verification to determine whether the suggested testing for the feature of the product can be performed; and instruction for generating, by a product testing instruction generator, product testing instruction after the verification is performed

### Specialized Processing System

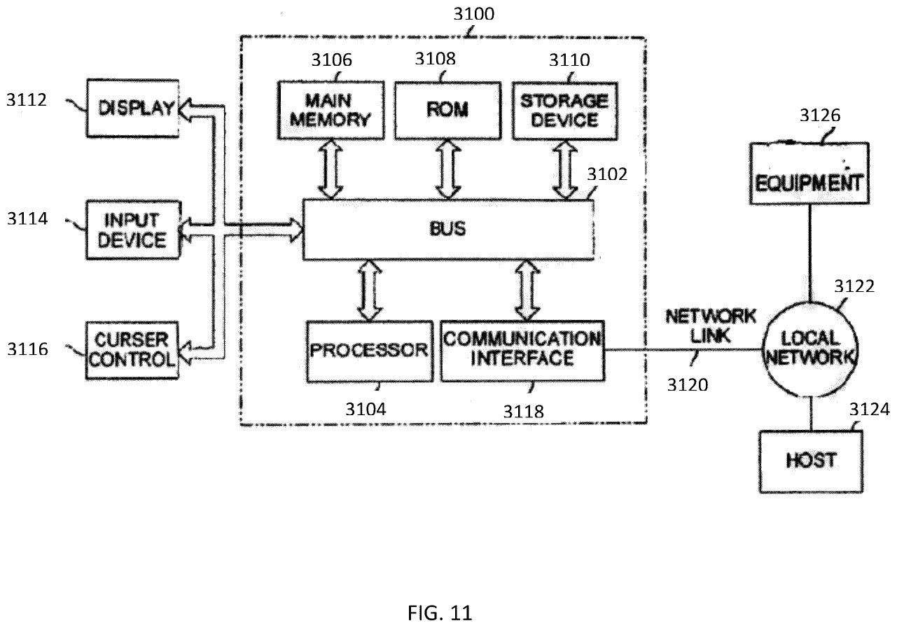

FIG. 11 is a block diagram illustrating an embodiment of a specialized processing system 3100 that can be used to implement various embodiments or features described herein. For example, the processing system 3100 may be used to implement the system 10 of FIG. 1 or FIG. 2, or any of the components therein. For example, the processing system 3100 may be used to implement the product retriever 110, the image capturer 120, the user interface generator 122, the processing unit 130, the processing unit 140, the processing unit 150, the testing instruction generator 160, the product testing device 180, the neural network 106, a component of any of the foregoing, or any combination of the foregoing. Furthermore, in some embodiments, the processing system 3100 may be considered a processing unit that is a part of the product retriever 110, the image capturer 120, the user interface generator 122, the processing unit 130, the processing unit 140, the processing unit 150, the testing instruction generator 160, the product testing device 180, the neural network 106, or any combination of the foregoing. In addition, in some embodiments, the processing system 3100 may implement one or more prompt generators described herein.

Processing system 3100 includes a bus 3102 or other communication mechanism for communicating information, and a processor 3104 coupled with the bus 3102 for processing information. The processor system 3100 also includes a main memory 3106, such as a random access memory (RAM) or other dynamic storage device, coupled to the bus 3102 for storing information and instructions to be executed by the processor 3104. The main memory 3106 also may be used for storing temporary variables or other intermediate information during execution of instructions to be executed by the processor 3104. The processor system 3100 further includes a read only memory (ROM) 3108 or other static storage device coupled to the bus 3102 for storing static information and instructions for the processor 3104. A data storage device 3110, such as a magnetic disk or optical disk, is provided and coupled to the bus 3102 for storing information and instructions.

The processor system 3100 may be coupled via the bus 3102 to a display 3112, such as a flat panel or a cathode ray tube (CRT), for displaying information to a user. An input device 3114, including alphanumeric and other keys, is coupled to the bus 3102 for communicating information and command selections to processor 3104. Another type of user input device is cursor control 3116, such as a mouse, a trackball, or cursor direction keys for communicating direction information and command selections to processor 3104 and for controlling cursor movement on display 3112. This input device typically has two degrees of freedom in two axes, a first axis (e.g., x) and a second axis (e.g., y), that allows the device to specify positions in a plane.

In some embodiments, the processor system 3100 can be used to perform various functions described herein. According to some embodiments, such use is provided by processor system 3100 in response to processor 3104 executing one or more sequences of one or more instructions contained in the main memory 3106. Those skilled in the art will know how to prepare such instructions based on the functions and methods described herein. Such instructions may be read into the main memory 3106 from another processor-readable medium, such as storage device 3110. Execution of the sequences of instructions contained in the main memory 3106 causes the processor 3104 to perform the process steps described herein. One or more processors in a multi-processing arrangement may also be employed to execute the sequences of instructions contained in the main memory 3106. In alternative embodiments, hard-wired circuitry may be used in place of or in combination with software instructions to implement the various embodiments described herein. Thus, embodiments are not limited to any specific combination of hardware circuitry and software.

The term “processor-readable medium” as used herein refers to any medium that participates in providing instructions to the processor 3104 for execution. Such a medium may take many forms, including but not limited to, non-volatile media, volatile media, and transmission media. Non-volatile media includes, for example, optical or magnetic disks, such as the storage device 3110. A non-volatile medium may be considered an example of non-transitory medium. Volatile media includes dynamic memory, such as the main memory 3106. A volatile medium may be considered an example of non-transitory medium. Transmission media includes coaxial cables, copper wire and fiber optics, including the wires that comprise the bus 3102. Transmission media can also take the form of acoustic or light waves, such as those generated during radio wave and infrared data communications.

Common forms of processor-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a processor can read.

Various forms of processor-readable media may be involved in carrying one or more sequences of one or more instructions to the processor 3104 for execution. For example, the instructions may initially be carried on a magnetic disk of a remote computer. The remote computer can load the instructions into its dynamic memory and send the instructions over a telephone line using a modem. A modem local to the processing system 3100 can receive the data on the telephone line and use an infrared transmitter to convert the data to an infrared signal. An infrared detector coupled to the bus 3102 can receive the data carried in the infrared signal and place the data on the bus 3102. The bus 3102 carries the data to the main memory 3106, from which the processor 3104 retrieves and executes the instructions. The instructions received by the main memory 3106 may optionally be stored on the storage device 3110 either before or after execution by the processor 3104.

The processing system 3100 also includes a communication interface 3118 coupled to the bus 3102. The communication interface 3118 provides a two-way data communication coupling to a network link 3120 that is connected to a local network 3122. For example, the communication interface 3118 may be an integrated services digital network (ISDN) card or a modem to provide a data communication connection to a corresponding type of telephone line. As another example, the communication interface 3118 may be a local area network (LAN) card to provide a data communication connection to a compatible LAN. Wireless links may also be implemented. In any such implementation, the communication interface 3118 sends and receives electrical, electromagnetic or optical signals that carry data streams representing various types of information.

The network link 3120 typically provides data communication through one or more networks to other devices. For example, the network link 3120 may provide a connection through local network 3122 to a host computer 3124 or to equipment 3126 such as a radiation beam source or a switch operatively coupled to a radiation beam source. The data streams transported over the network link 3120 can comprise electrical, electromagnetic or optical signals. The signals through the various networks and the signals on the network link 3120 and through the communication interface 3118, which carry data to and from the processing system 3100, are exemplary forms of carrier waves transporting the information. The processing system 3100 can send messages and receive data, including program code, through the network(s), the network link 3120, and the communication interface 3118.

It should be noted that as used in this specification, the term “image” is not limited to an image that is displayed, and may also include image that is not displayed, such as image data stored in a non-transitory medium. Similarly, as used in this specification, the term “video” is not limited to a video that is displayed, and may also include video that is not displayed, such as video data stored in a non-transitory medium.

Also, as used in this specification, the terms “first”, “second”, “third”, etc., do not necessarily refer to order of items. Rather, these terms may be used to distinguish different items from each other. For example, “first product tester” does not necessarily mean that the product tester is the first in order. Also, “second product tester” does not necessarily mean that the product tester is the second in order. Rather, these terms are used to identify two different product testers.

Furthermore, as used in this specification, the term “machine” (as in the term “product testing machine”) may refer to a device, a component, a system, an application, software, a virtual machine, or any form of a processing unit or module, that is configured to perform one or more desired functions. In some embodiments, a machine may include at least some hardware. Similarly, as used in this specification, the term “device” may refer to a physical device, a component, a system, an application, software, a virtual machine, or any form of a processing unit or module, that is configured to perform one or more desired functions. In some embodiments, a device may include at least some hardware.

In addition, as used in this specification, the term “processing unit” may refer to hardware, software, or combination thereof. Also, the term “processing unit” may refer to one or more processors, one or more pieces of software or applications, one or more computing systems or component(s) thereof, one or more virtual machines or component(s) thereof, etc. In one implementation, a processing unit may include at least some hardware.

Although particular embodiments have been shown and described, it will be understood that they are not intended to limit the present inventions, and it will be obvious to those skilled in the art that various changes and modifications may be made without departing from the spirit and scope of the present inventions. The specification and drawings are, accordingly, to be regarded in an illustrative rather than restrictive sense. The present inventions are intended to cover alternatives, modifications, and equivalents, which may be included within the spirit and scope of the present inventions as defined by the claims.

1. An electronic system, comprising:
a product retriever configured to access a product;
an image capturer configured to capture one or more images of the product; and
one or more processing units configured to generate prompts for input to a neural network, wherein the prompts are configured to prompt the neural network to determine a feature of the product based on at least one of the one or more captured images, determine a suggested testing for the feature of the product, perform a verification to determine whether the suggested testing for the feature of the product can be performed, and generate product testing instruction after the verification is performed.

2. The electronic system of claim 1, wherein the prompts comprise a first set of prompts, and wherein the one or more processing units comprises a first prompt generator configured to generate the first set of prompts to cause the neural network to determine the feature of the product based on the at least one of the one or more captured images.

3. The electronic system of claim 2, wherein the prompts comprise a second set of prompts, and wherein the one or more processing unit comprises a second prompt generator configured to generate the second set of prompts to cause the neural network to perform the verification to determine whether the suggested testing for the feature of the product can be performed.

4. The electronic system of claim 3, wherein the prompts comprise a third set of prompts, and wherein the one or more processing units comprises a third prompt generator configured to generate the third set of prompts to cause the neural network to generate the product testing instruction.

5. The electronic system of claim 4, wherein the one or more processing units are configured to obtain OCR data and/or DOM data, and to provide the OCR data and/or the DOM data along with the third set of prompts to cause the neural network to generate the product testing instruction based on at least a part of the OCR data and/or at least a part of the DOM data.

6. The electronic system of claim 1, wherein the neural network is separate from the one or more processing units, and wherein the one or more processing units are configured to access the neural network.

7. The electronic system of claim 1, wherein the one or more processing units comprise the neural network.

8. The electronic system of claim 1, wherein the neural network comprises a plurality of neural network models, and wherein the one or more processing units are configured to access respective ones of the neural network models.

9. The electronic system of claim 1, wherein the neural network comprises a plurality of neural network models, and wherein the one or more processing units comprise respective ones of the neural network models.

10. The electronic system of claim 1, wherein the neural network comprises ChatGPT.

11. The electronic system of claim 1, wherein the one or more processing units are configured to obtain feedback from the neural network indicating that the suggested testing for the feature of the product cannot be performed.

12. The electronic system of claim 11, wherein the one or more processing units are configured to generate additional prompts based on the feedback to cause the neural network to determine another feature of the product and/or to determine another suggested testing.

13. The electronic system of claim 1, further comprising:
a product testing device configured to execute the product testing instruction to perform testing of the product based on the product testing instruction,
wherein the product testing device is configured to perform the testing of the product by simulating human actions based on the product testing instruction.

14. The electronic system of claim 13, wherein the product testing device is configured to move a cursor without input from a cursor control.

15. The electronic system of claim 13, wherein the product testing device is configured to make a selection of an object without input from a cursor control.

16. The electronic system of claim 13, wherein the product testing device is configured to insert a text in a field without input from a keyboard.

17. The electronic system of claim 13, wherein the product testing device comprises an interpreter configured to interpret the product testing instruction.

18. The electronic system of claim 1, wherein the one or more processing units are configured to access a first set of items and a second set of items for the neural network or to provide the first set of items and the second set of items for access by the neural network, wherein the first set of items comprises a plurality of action identifiers, and the second set of items comprises a plurality of objects.

19. The electronic system of claim 18, wherein one of the action identifiers identifies an action to be performed by the product testing device, and one of the object identifiers identifies an object on which the action is to be performed by the product testing device.

20. The electronic system of claim 18, wherein one of the action identifiers identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

21. The electronic system of claim 18, wherein one of the object identifiers identifies a button, a field, a dropdown menu, a dropdown option, a link, an icon, a checkbox, a header, a window, a text, a modal, or an user interface element.

22. The electronic system of claim 1, wherein the product testing instruction has a data structure that associates an action identifier with a corresponding object identifier:

23. The electronic system of claim 22, wherein the action identifier identifies an action to be performed by the product testing device, and the object identifier identifies an object on which the action is to be performed by the product testing device.

24. The electronic system of claim 22, wherein the action identifier identifies a click action, a fill action, a type action, a press key action, a hover action, a dropdown select action, a checkbox check action, a checkbox uncheck action, a refresh action, a navigate action, a new tab action, a close tab action, a scroll cation, a drag and drop action, or a click and hold action.

25. The electronic system of claim 22, wherein the object identifier identifies a button, a field, a dropdown menu, a dropdown option, a link, an icon, a checkbox, a header, a window, a text, a modal, or an user interface element.

26. The electronic system of claim 1, further comprising a non-transitory medium storing the product testing instruction in association with an identity of the product.

27. The electronic system of claim 13, wherein the product testing device is configured to check if an element is visible after the product testing device performs a testing action.

28. The electronic system of claim 13, wherein the product testing device is configured to check if an element is not visible after the product testing device performs a testing action.

29. The electronic system of claim 13, wherein the product testing device is configured to check if a specified page has loaded after the product testing device performs a testing action.

30. The electronic system of claim 13, wherein the product testing device is configured to:
obtain a first image that is associated with the testing of the product,
obtain a second image, the second image being a reference image that is pre-determined before the first image is obtained,
perform a comparison based on the first image and the second image, and
determine whether the product passes or fails a product testing task based on a result of the comparison.

31. The electronic system of claim 30, wherein the first image is based on a completion of the product testing task performed during the testing of the product.

32. The electronic system of claim 1, wherein the product comprises a web page, a web site, a computer application, a mobile device application, or a processor application.

33. The electronic system of claim 1, wherein the one or more processing units comprise an action retriever configured to obtain past testing information regarding past human-testing action and/or past machine-testing action, and to provide the past testing information to the neural network for guiding an operation of the neural network.

34. A method performed by an electronic system, the method comprising:
accessing a product;
capturing one or more images of the product by an image capturer of the electronic system; and
generating, by one or more processing units of the electronic system, prompts for input to a neural network, wherein the prompts are configured to prompt the neural network to:
determine a feature of the product based on at least one of the one or more captured images,
determine a suggested testing for the feature of the product,
perform a verification to determine whether the suggested testing for the feature of the product can be performed, and
generate product testing instruction after the verification is performed.

35-66. (canceled)
